(19) United States
(12) Patent Application Publication
(10) Pub. No.: US 2025/0313303 A1
(43) Pub. Date: Oct. 9, 2025

(54) TRANSMISSION SYSTEM FOR A HUMAN POWERED VEHICLE, OR LIGHT ELECTRIC VEHICLE

(71) Applicant: Classified Cycling BV, Antwerpen (BE)

(72) Inventor: Roëll Marie VAN DRUTEN, Eindhoven (NL)

(21) Appl. No.: 19/172,223

(22) Filed: Apr. 7, 2025

(30) Foreign Application Priority Data
Apr. 8, 2024 (NL) 2037413

(51) Int. Cl. B62M 11/18; B62M 6/65

(52) U.S. Cl. CPC B62M 11/18; B62M 6/65

(57) ABSTRACT

The disclosure relates to a transmission system for a human powered vehicle, or light electric vehicle, comprising a crank housing, a crank axle, a front sprocket mounted to an output shaft concentric with the crank axle, and a transmission having an input connected to the crank axle and an output connected to the output shaft. The transmission comprises a planetary gear system, configured to be operated according one of a plurality of different selectable transmission ratios, mounted on a lay shaft which is offset and parallel to the crank axle, and an input transmission stage for transmitting torque from the crank axle to an input of the planetary gear system, wherein the input transmission stage has a speed increasing transmission ratio.

### CLAIM FOR PRIORITY

This application claims the benefit of priority of Dutch Application No. 2037413, filed Apr. 8, 2024, which is hereby incorporated by reference in its entirety.

### FIELD

The invention relates to a transmission system for a human powered vehicle, or light electric vehicle, such as for a bicycle.

### BACKGROUND

Bicycle transmission systems are known per se. Many bicycle transmission systems are configured to provide a plurality of different transmission ratios.

A known class of bicycle transmission systems is based on a chain connecting a front chain wheel and a rear sprocket, wherein the rear sprocket is one of a plurality of rear sprockets, e.g. combined in a cassette, and a rear derailleur is provided for providing selectable different transmission ratios. Alternatively, or additionally, the front chain wheel is one of a plurality of front chain wheels, and a front derailleur is provided for providing selectable different transmission ratios.

Another known class of bicycle transmission systems uses encased transmissions. Such encased transmissions can e.g. be internally geared bicycle hub transmissions. Such encased transmissions can be internally geared crank units. The encased transmissions can be used in combination with a derailleur system.

Present encased transmission systems can have the disadvantage of having few different transmission ratios. Present encased transmission systems with more transmission ratios often have the disadvantage of being heavy.

### SUMMARY

It is an object to propose an improved transmission system for a human powered vehicle or light electric vehicle, such as a bicycle. It will be appreciated that the transmission system can be used in various vehicles, such as bicycles or other human powered vehicles or light electric vehicles. It is an object to provide an improved crank transmission system for a human powered vehicle or light electric vehicle, such as a bicycle.

According to an aspect is provided a transmission system for a human powered vehicle, or light electric vehicle, such as a bicycle. The transmission system comprising a crank housing, a crank axle and a front sprocket mounted to an output shaft concentric with the crank axle. The transmission system comprises a transmission having an input connected to the crank axle and an output connected to the output shaft. The transmission comprises a planetary gear system, configured to be operated according one of a plurality of different selectable transmission ratios, mounted on a lay shaft which is offset and parallel to the crank axle. The lay shaft can be configured to be fixed against rotation. The lay shaft can e.g. be non-rotatably fixed or fixable to the crank housing. The transmission comprises an input transmission stage for transmitting torque from the crank axle to an input of the planetary gear system, wherein the input transmission stage can have a speed increasing transmission ratio. The speed increasing transmission ratio of the input transmission stage can reduce torque on the planetary gear system. Hence, the planetary gear system can be built lighter.

Optionally, the transmission comprises an output transmission stage for transmitting torque from an output of the planetary gear system to the output shaft. The output transmission stage can have a speed increasing transmission ratio.

Optionally, the planetary gear system has speed increasing and/or speed decreasing transmission ratios. Optionally, the planetary gear system also has a unity transmission ratio.

Optionally, all transmission ratios of the transmission are speed increasing. Hence, an effective transmission ratio of the input transmission stage, the planetary gear system and the output transmission stage combined can be speed increasing for all possible selectable transmission ratios of the transmission.

Optionally, the transmission system comprises a one way bearing coupling the crank axle to the output shaft. Hence, a direct 1:1 transmission ration can be obtained from the crank axle to the output shaft. In case the transmission having only speed increasing selectable transmission ratios is selected to idle, the one way bearing can provide a lowest unity transmission ration of the transmission system. Hence, in a simple way an additional transmission ration can be provided.

According to an aspect is provided a transmission system for a human powered vehicle, or light electric vehicle, such as a bicycle. The transmission system comprising a crank housing, a crank axle and a front sprocket mounted to an output shaft concentric with the crank axle. The transmission system comprises a transmission having an input connected to the crank axle and an output connected to the output shaft. At least part of the transmission is mounted concentric with a lay shaft which is offset and parallel to the crank axle. The lay shaft can be configured to be fixed against rotation. The lay shaft can e.g. be non-rotatably fixed or fixable to the crank housing. The transmission system comprises a one way bearing coupling the crank axle to the output shaft. Hence, a direct 1:1 transmission ration can be obtained from the crank axle to the output shaft.

Optionally, the transmission comprises a planetary gear system configured to be operated according one of a plurality of different selectable transmission ratios mounted on the lay shaft.

Optionally, the transmission comprises an input transmission stage for transmitting torque from the crank axle to an input of the planetary gear system. The input transmission stage can have a speed increasing transmission ratio. The speed increasing transmission ratio of the input transmission stage can reduce torque on the planetary gear system. Hence, the planetary gear system can be built lighter.

Optionally, the transmission comprises an output transmission stage for transmitting torque from an output of the planetary gear system to the output shaft. The output transmission stage can have a speed increasing transmission ratio.

Optionally, the planetary gear system has speed increasing and/or speed decreasing transmission ratios. Optionally, the planetary gear system also has a unity transmission ratio.

Optionally, all transmission ratios of the transmission are speed increasing. Hence, the effective transmission ratio of the input transmission stage, the planetary gear system and the output transmission stage combined can be speed increasing for all possible selectable transmission ratios of the transmission. In case the transmission having only speed increasing selectable transmission ratios is selected to idle, the one way bearing can provide a lowest, unity, transmission ratio of the transmission system. Hence, in a simple way an additional transmission ratio can be provided.

For the above aspects the following applies.

Optionally, the input transmission stage comprises a first gear mounted to the crank axle and a meshing second gear mounted to the input of the planetary gear system. Hence, the crank axle can drive the planetary gear system via the meshing first and second gears. This provides a simple structure and allows small build. The input transmission stage can be speed increasing, e.g. having a ratio of between 1:1 and 2:1. Hence, e.g. a speed-increasing geared can be provided between the crank axle and the input of the planetary gear system, for instance having a transmission ratio between 1:1 and 2:1.

Optionally, the output transmission stage comprises a third gear mounted to the output of the planetary gear system and a meshing fourth gear mounted to the output shaft. Hence, the planetary gear system can drive the output shaft via the meshing third and fourth gears. This provides a simple structure and allows small build.

Optionally, the product of the transmission ratio of the input transmission stage times the output transmission stage is larger than the inverse of the smallest (underdrive) transmission ratio of the planetary gear system.

Optionally, the product of the transmission ratio of the input transmission stage times the output transmission stage times the smallest (underdrive) transmission ratio of the planetary gear system is larger than one (1).

Optionally, a transmission ratio step size from unity transmission ratio of the transmission system to the next higher transmission ratio of the transmission system is larger than a transmission ratio step size of the planetary gear system.

Optionally, the input transmission stage comprises a first torque transfer path having a first transmission ratio and a second torque transfer path having a different second transmission ratio, wherein the input transmission stage is configured for selectively transferring torque to the input of the planetary gear system via the first torque transfer path or the second torque transfer path. Both the first and second torque transfer path can have a transmission ratio of between 1:1 and 2:1. The second torque transfer path can be more speed increasing than first torque transfer path, i.e. a transmission ratio of the second torque transfer path can be larger than a transmission ratio of the second torque transfer path. A transmission ratio difference, in particular a relative transmission ratio difference, between the first torque transfer path and the second torque transfer path can be smaller than a transmission ratio step size between successive transmission ratios of the planetary gear system. The transmission ratio difference, in particular the relative transmission ratio difference, between the first torque transfer path and the second torque transfer path can e.g. be about half of the transmission ratio step size between successive transmission ratios of the planetary gear system. Hence, the first and second torque transfer paths can provide intermediate transmission ratios between the transmission ratios provided by the planetary gear system.

Optionally, a range of the transmission ratios of the planetary gear system is 450% or more.

The first torque transfer path can comprise the first gear and the second gear. The second torque transfer path can comprises a fifth gear mounted to the crank axle and a meshing sixth gear mounted to the input of the planetary gear system. Hence torque can be transferred from the crank axle to the input of the planetary gear system selectively via the first and second gears or via the fifth and sixth gears. Thereto the first or fifth gear may de selectively coupled to the crank axle and/or the second or sixth gear may be selectively coupled to the input of the planetary gear system.

The transmission system can e.g. comprise a freewheel in the first torque transfer path. The transmission system can e.g. comprise a third actuatable clutch in the second torque transfer path. The third actuatable clutch and the freewheel allow selectively transferring torque to the input of the planetary gear system via the first torque transfer path or the second torque transfer path. The third actuatable clutch can have a separate electronic actuator. The third actuatable clutch can be configured to shift under load. The third actuatable clutch can e.g. be configured to couple/decouple the sixth gear with the input of the planetary gear system. The third actuatable clutch can be concentric with the lay shaft.

Alternatively, or additionally, the output transmission stage comprises a third torque transfer path having a third transmission ratio and a fourth torque transfer path having a different fourth transmission ratio, wherein the output transmission stage is configured for selectively transferring torque to the output shaft via the third torque transfer path or the fourth torque transfer path. Both the third and fourth torque transfer path can have a transmission ratio of between 1:1 and 2:1. The fourth torque transfer path can be more speed increasing than third torque transfer path, i.e. a transmission ratio of the fourth torque transfer path can be larger than a transmission ratio of the third torque transfer path. A transmission ratio difference, in particular a relative transmission ratio difference, between the third torque transfer path and the fourth torque transfer path can be smaller than the transmission ratio step size between successive transmission ratios of the planetary gear system. The transmission ratio difference, in particular the relative transmission ratio difference, between the third torque transfer path and the fourth torque transfer path can e.g. be about half of the transmission ratio step size between successive transmission ratios of the planetary gear system. Hence, the third and fourth torque transfer paths can provide intermediate transmission ratios between the transmission ratios provided by the planetary gear system.

In case the transmission system comprises the first, second, third and fourth torque transfer path, the transmission ratio difference, in particular the relative transmission ratio difference, between the third torque transfer path and the fourth torque transfer path can e.g. be about half of the transmission ratio step size between successive transmission ratios of the planetary gear system, and the transmission ratio difference, in particular the relative transmission ratio difference, between the first torque transfer path and the second torque transfer path can e.g. be about a fourth of the transmission ratio step size between successive transmission ratios of the planetary gear system. Alternatively, the transmission ratio difference, in particular the relative transmission ratio difference, between the third torque transfer path and the fourth torque transfer path can e.g. be about a fourth of the transmission ratio step size between successive transmission ratios of the planetary gear system, and the transmission ratio difference, in particular the relative transmission ratio difference, between the first torque transfer path and the second torque transfer path can e.g. be about half of the transmission ratio step size between successive transmission ratios of the planetary gear system.

The third torque transfer path can comprise the third gear and the fourth gear. The fourth torque transfer path can comprises a seventh gear mounted to the output of the planetary gear system and a meshing eighth gear mounted to the output shaft. Hence torque can be transferred from the output of the planetary gear system to the output shaft selectively via the third and fourth gears or via the seventh and eighth gears. Thereto the third or seventh gear may de selectively coupled to the output of the planetary gear system and/or the fourth or eighth gear may be selectively coupled to the output shaft.

The transmission system can e.g. comprise a freewheel in the third torque transfer path. The transmission system can e.g. comprise a fourth actuatable clutch in the fourth torque path. The fourth actuatable clutch and the freewheel allow selectively transferring torque to the output shaft via the third torque transfer path or the fourth torque transfer path. The fourth actuatable clutch can have a separate electronic actuator. The fourth actuatable clutch can be configured to shift under load. The fourth actuatable clutch can e.g. be configured to couple/decouple the seventh gear with the output of the planetary gear system. The fourth actuatable clutch can be concentric with the lay shaft.

Optionally, the lay shaft is configured to be non-rotatably fixed or fixable to the crank housing.

The planetary gear system can comprise at least one sun gear rotatably mounted around the lay shaft, and at least one clutch mechanism configured for in a first mode selectively preventing rotation of the at least one sun gear in a first rotational direction about the lay shaft, and in a second mode selectively preventing rotation of the at least one sun gear in an opposite second rotational direction about the lay shaft. The at least one clutch mechanism can be configured to be actively electronically actuated to select the respective mode of the clutch mechanism. Optionally, the at least one clutch mechanism is configured for in a third mode allowing the sun gear to rotate freely around the axle in at least one or both rotational directions. The at least one clutch mechanism can comprises a respective clutch mechanism associated with each of the sun gears for selecting at least the first and second modes. Hence, each sun gear can have an associated clutch mechanism. Each sun gear can be associated with one of the clutch mechanisms and each clutch mechanism can be associated with one of the sun gears.

Optionally, the at least one sun gear comprises at least two or at least three sun gears rotatably mounted around the axle, and the at least one clutch mechanism comprises a respective clutch mechanism associated with each of the sun gears for selecting at least the first and second modes. the planetary gear system can comprise at least three sun gears rotatably mounted around the lay shaft, configured for in the first mode selectively being prevented to rotate in the first rotational direction about the lay shaft, and optionally in the second mode selectively being prevented to rotate in the opposite second rotational direction about the lay shaft. The at least two or at least three sun gears can have different diameters and can be connected by at last one stepped planet gear rotatably mounted inside a carrier. Optionally, a largest planet part of the at least one stepped planet gear is positioned towards the input of the planetary gear system.

Optionally, the transmission system comprises a ring gear meshing with one of the planets of the stepped planet gear(s).

Optionally, the planetary gear system is configured to be operated according to at least five different selectable transmission ratios, and the input and output transmission stages are configured to, together, be operated according to at least three different selectable transmission ratios.

Optionally, the planetary gear system is configured to be operated according to at least seven different selectable transmission ratios, and the input and output transmission stages are configured to, together, be operated according to at least two different selectable transmission ratios.

Optionally, the or each clutch mechanism comprises a first pawl and a second pawl configured to be actuated by a camshaft, such that the first pawl is selectively in engagement with the respective sun gear in the first mode, and the second pawl is selectively in engagement with the respective sun gear in the second mode. The first and second pawls may be biased to disengage from the respective sun gear. The camshaft can selectively maintain the first pawl in engagement with the respective sun gear in the first mode, and the second pawl in engagement with the respective sun gear in the second mode. The camshaft can selectively lock the first pawl in engagement with the respective sun gear in the first mode, and the second pawl in engagement with the respective sun gear in the second mode. The camshaft can comprise a cam to selectively lock the first pawl in engagement with the respective sun gear in the first mode, and the second pawl in engagement with the respective sun gear in the second mode.

Optionally, at least one of the clutch mechanisms comprises a passive one-way clutch or one-way bearing to create a first or second mode.

Optionally, the input of the planetary gear system is connectable either to the ring gear or to the carrier of the planetary gear set. The planetary gear system can be configured to selectively transfer torque from the input of the planetary gear system to the ring gear or to the carrier of the planetary gear set. The input of the planetary gear system can be connected to the ring gear via a one-way clutch or one-way bearing. The input of the planetary gear system can be connected to the carrier via a first actuatable clutch mechanism. Optionally, an output of the planetary gear system is connectable either to the ring gear or to the carrier of the planetary gear set. The planetary gear system can be configured to selectively transfer torque from the ring gear or the carrier of the planetary gear set to the output of the planetary gear system. The carrier can be connected to the output of the planetary gear system via a one-way clutch or one-way bearing. The ring gear can be connected to the output of the planetary gear system via a second actuatable clutch mechanism. The first actuatable clutch and the second actuatable clutch can be part of a switching mechanism. This allows to selectively connect the input of the planetary gear system to the carrier and the ring gear to the output of the planetary gear system, or connect the input of the planetary gear system to the ring gear and the carrier to the output of the planetary gear system. Hence, the number of useable transmission ratios can be increased. It is also possible to connect the input of the planetary gear system and the output of the planetary gear system both to the carrier or both to the ring gear to provide a unity transmission ratio.

Optionally, the lay shaft is configured to support torque from the planetary gear system onto the crank housing (only) on the output side of the planetary gear system.

Optionally, the planetary gear system is configured to selectively transfer torque from the input of the planetary gear system to the ring gear or to the carrier of the planetary gear set.

Optionally the camshaft is mounted inside the axle for actuating the at least one clutch mechanism. Optionally, the camshaft mounted inside the axle is configured for actuating the respective clutch mechanisms of the at least one clutch mechanism. Hence, the camshaft can actuate a plurality of clutch mechanisms. Optionally, the camshaft mounted inside the axle is configured for actuating the first and second actuatable clutch mechanisms. Hence, the camshaft can actuate the connecting of the input and output of the transmission to the ring gear and carrier as described above.

Optionally, the at least one clutch mechanism is designed such that it can disengage from a torque loaded sun gear, in at least one direction.

Optionally, the pawls are designed such that they disengage under torque load on the sun gear, and that the camshaft is configured to allow to prevent disengagement.

Optionally, between the camshaft and the pawls there is a roller bearing.

Optionally, between the camshaft and axle there is at least one roller bearing.

Optionally, an offset distance between the lay shaft and crank axle is 60 mm or smaller. Hence, a small build can be obtained.

Optionally, the transmission system comprises an electric propulsion motor. The electric motor can be connected to the input of the transmission system or the input of the planetary gear system. In particular, the electric motor can be connected to the input of the planetary gear system downstream of the input transmission stage. The electric motor can e.g. drive an output of the input transmission stage. It is also possible, that the electric motor drives the output of the planetary gear system or the output shaft. The electric motor can be concentric with the crank axle. The electric motor can be offset and parallel to the crank axle.

According to an aspect is provided a human powered vehicle or light electric vehicle, such as a bicycle, comprising the transmission system as described hereinabove.

Optionally, the comprises an electric propulsion motor concentrically connected to a rear wheel and/or comprises an electric propulsion motor concentrically connected to a front wheel of the vehicle.

It will be appreciated that any of the aspects, features and options described herein can be combined. Any of the aspects, features and options described in view of the transmission systems apply equally to the human powered vehicle or light electric vehicle, such as the bicycle.

### BRIEF DESCRIPTION OF THE DRAWINGS

Embodiments of the present invention will now be described in detail with reference to the accompanying drawings in which:

FIG. 1 shows a schematic example of a transmission;

FIGS. 2A-2C show an example of an actuator;

FIGS. 3A-3I show an example of a sequence of gear shifting;

FIG. 4A shows an example of a freewheel clutch;

FIG. 4B shows an example of an actuatable bidirectional clutch mechanism;

FIGS. 5A and 5B show examples of an actuatable clutch of a shifting mechanism;

FIGS. 6A and 6B show an example of an actuator;

FIG. 7A shows an example of a spring;

FIG. 7B shows an example of a clutch;

FIGS. 8A and 8B show an example of a selector;

FIGS. 9A, 9B and 9C show an example of a selector;

FIGS. 10A, 10B and 10C show an example of a selector;

FIG. 11 shows an example of a transmission system;

FIG. 12 shows an example of a transmission system;

FIG. 13 shows an example of a transmission system;

FIG. 14 shows an example of a transmission system;

FIGS. 15A and 15B show an example of a transmission system; and

FIG. 16 shows an example of a bicycle.

### DETAILED DESCRIPTION

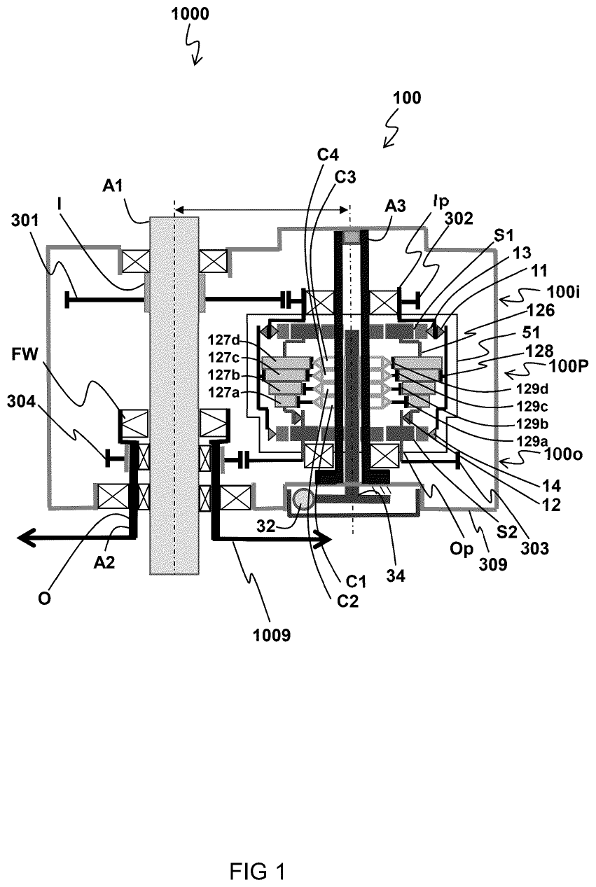

FIG. 1 shows a schematic example of a transmission system 1000 for a human powered vehicle or light electric vehicle, such as bicycle. Here, the transmission system 1000 is embodied as a crank transmission. The transmission system 1000 comprises a crank housing 309. The transmission system 1000 includes a transmission 100 including a transmission input I and a transmission output O. Here, the input I is connected to a crank axle A1. The output O is connected to an output shaft A2. The output shaft A2 is in this example concentric with the crank axle A1. A front sprocket 1009 is connected to the output shaft A2, so as to be driven in rotation by the output shaft A2. At least a part of the transmission is mounted concentric with a lay shaft A3.

In this example, the transmission 100 comprises a planetary gear system 100P. The planetary gear system 100P is configured to be operated according one of a plurality of different selectable transmission ratios. The planetary gear system 100P is mounted on the lay shaft A3. Here, the transmission 100 further comprises an input transmission stage 100i for transmitting torque from the crank axle A1 to an input Ip of the planetary gear system 100P. Here, the transmission 100 further comprises an output transmission stage 100o for transmitting torque from an output Op of the planetary gear system 100P to the output shaft A2.

In the example of FIG. 1, the input transmission stage 100i has a speed increasing transmission ratio. This transmission ratio can e.g. be between 1:1 and 2:1. The speed increasing transmission ratio of the input transmission stage can reduce torque on the planetary gear system 100P. The input transmission stage 100i comprises a first gear 301 mounted to the crank axle A1 and a meshing second gear 302 mounted to the input Ip of the planetary gear system 100P. It will be appreciated that it is also possible that the first gear 301 drives the second gear 302 via an endless drive member such as a belt or chain.

In this example, the output transmission stage 100o has a speed increasing transmission ratio. This transmission ratio can e.g. be between 1:1 and 2:1. The output transmission stage 100o comprises a third gear 303 mounted to the output Op of the planetary gear system 100P and a meshing fourth gear 304 mounted to the output shaft A2. It will be appreciated that it is also possible that the third gear 303 drives the fourth gear 304 via an endless drive member such as a belt or chain.

In the example of FIG. 1, the planetary gear system 100P is arranged for providing a speed reduction and/or speed increase between the input Ip and the output Op. The planetary gear system may be housed in a, e.g. rotatable, housing 51. The planetary gear system 100P comprises a ring gear 128 and a planet carrier 126 carrying one or more planet gears 127. The planet carrier 126 in this example carries one or more stepped planet gears 127 having multiple planet gear parts 127i having different planet radii. In this example, the stepped planet gear has four planet gear parts 127a, 127b, 127c, 127d. The ring gear 128 meshes with one of the different planet radii 127i. Here, the ring gear 128 meshes with the third planet gear part 127c. The planetary gear system 100P also comprises a plurality of different sun gears 129i. The plurality of sun gears respectively mesh with the plurality of different planet radii 127i. Here, the plurality of sun gears comprises four sun gears 129a, 129b, 129c, 129d. Notice that in this example, the sun gears 129i are positioned with ever increasing diameters from one end of the lay shaft A2 to the other end of the lay shaft. This can be beneficial in combination with an ever increasing lay shaft diameter corresponding to the increasing sun gear diameter as described below. The same applies to the planet gear parts 127i. It is, however, also possible to position the sun gear 129d with the smallest diameter between two sun gears of larger diameter. This can provide a compact build. Similarly, positioning the planet gear parts 127d with the largest diameter between two planet gear parts of smaller diameter can provide a compact build.

The sun gears 129i are rotatably arranged about the lay shaft A2. The lay shaft A2 is here stationary relative to the crank housing 309. The stationary lay shaft A2 may be mounted to the housing 309, for supporting torque thereon. Therefore, the lay shaft may be mounted fixed against rotation relative to a frame of the vehicle.

The planetary gear system 100P comprises a switching mechanism. The switching mechanism comprises a first actuatable clutch mechanism S1 and a second actuatable clutch mechanism S2. the first actuatable clutch mechanism S1 is arranged in a transmission path between the input Ip of the planetary gear system 100P and the carrier 126. The second actuatable clutch mechanism S2 is arranged in a transmission path between the ring gear 128 and the output Op of the planetary gear system 100P. The planetary gear system 100P also comprises a first freewheel 11 in a transmission path between the transmission input Ip and the planet ring gear 128. The first freewheel 11 is hence parallel to the first actuatable clutch mechanism S1. The planetary gear system 100P also comprises a second freewheel 12 in a transmission path between the carrier 126 and the transmission output O. The second freewheel 12 is hence parallel to the second actuatable clutch mechanism S2.

The first switching mechanism is configured for selectively being in a first state or a second state.

In the first state of the switching mechanism, both the first and the second actuatable clutch mechanisms S1, S2 are in an unclutched state. Torque can accordingly be transmitted in the first state from the input Ip via the first freewheel 11 to the ring gear 128 and from the planet carrier 126 via the second freewheel 13 to the output Op. In the first state, the planetary gear set 100 provides a speed reduction from the ring gear 128 to the planet carrier 126 in accordance with the relative dimensions of the cooperating rotational members of the planetary gear set 100.

In the second state, both the first and the second actuatable clutch mechanisms S1, S2 are in a clutched state. Torque can accordingly be transmitted in the second state from the input Ip via the first actuatable clutch mechanism S1 to the planet carrier 126 and from the ring gear 128 via the second actuatable clutch mechanism S2 to the transmission output O. The first freewheel 11 and the second freewheel 12 are overrun in the first state. In this state, the planetary gear set 100 provides a speed increase from the planet carrier 126 to the ring gear 128 in accordance with the relative dimensions of the cooperating rotational members of the planetary gear set 100.

Here, the transmission 100 also comprises an optional third freewheel 13 arranged in series with the first actuatable clutch S1, and an optional fourth freewheel 14 arranged in series with the second actuatable clutch S2. The third and fourth freewheels 13 and 14 can prevent lockup of the transmission 100 if the vehicle were to be rolled backwards.

The switching mechanism enables for reversing a transmission path through the planetary gear set, e.g. from ring gear 128 to carrier 126 or vice versa, to effectively increase the range of transmission ratios of the planetary gear system 100P as whole. In the first state of the switching mechanism, the planetary gear system 100P operates according to an underdrive transmission ratio, reducing the rotational speed from the planetary gear system input Ip to the planetary gear system output Op. In the second state of the switching mechanism, the planetary gear system 100P operates according to an overdrive transmission ratio, increasing the rotational speed from the planetary gear system input Ip to the planetary gear system output Op.

The switching mechanism may also be arranged for selectively being in a third state. In the third state, the first actuatable clutch mechanism S1 may be in its clutched state, while the second actuatable clutch mechanism S2 is in its unclutched state, or vice versa. In the third state, the planetary gear system input Ip and the planetary gear system output Op are coupled to the same rotational member of the planetary gear set, e.g. both to the planet carrier 126 or both to the ring gear 128. In the third state, the planetary gear system 100P may be operable according to a unitary transmission ratio, e.g. a transmission ratio of 1:1.

While the planetary gear system 100P can have underdrive and overdrive transmission ratios (an optionally a unity transmission ratio), it can be beneficial to select transmission ratios of the input transmission stage 100i and/or output transmission stage 100o, such that a total transmission ratio of the transmission 100, i.e. the series connection of the input transmission stage 100i, the planetary gear system 100P, and the output transmission stage 100o is speed increasing for all possible transmission ratios of the transmission 100.

In this example, the transmission system comprises a freewheel or one way bearing FW, coupling the crank axle A1 to the output shaft A2. In case the transmission 100 having only speed increasing selectable transmission ratios is selected to idle, the one way bearing FW can provide a lowest, unity, transmission ratio of the transmission system 100o. Hence, in a simple way an additional transmission ratio can be provided.

The transmission 100 further comprises a clutch mechanism. The clutch mechanism is arranged for selectively clutching a selective one of the plurality of sun gears 129i to the lay shaft A3. Hereto, the clutch mechanism comprises a plurality of actuatable bidirectional clutch mechanisms Ci. In this example, the plurality of actuatable bidirectional clutch mechanisms Ci comprises four actuatable bidirectional clutch mechanisms C1, C2, C3, C4. Each actuatable bidirectional clutch mechanism Ci is associated with a respective sun gear 129i, for clutching the associated sun gear 129i to the stationary lay shaft A3 in a selective one of two opposing rotation directions. Each actuatable bidirectional clutch mechanism Ci is arranged for being selectively in a first disposition or a second disposition. In the first disposition, the actuatable bidirectional clutch mechanism Ci prevents rotation of the respective sun gear 129i in the first rotation direction about the stationary lay shaft A3. Herein, preventing rotation of the respective sun gear 129i in the first rotation direction about the stationary lay shaft A3 is also referred to as braking the respective sun gear 129i in the first rotation direction. In the second disposition, the actuatable bidirectional clutch mechanism C2.i prevents rotation of the respective sun gear 129i in the second rotation direction about the stationary lay shaft A3. Herein, preventing rotation of the respective sun gear 129i in the second rotation direction about the stationary lay shaft A3 is also referred to as braking the respective sun gear 129i in the second rotation direction. The direction in which a sun gear 129i is to be braked is dependent on the state of the switching mechanism. For example, if the switching mechanism is in its first state, a selective one of the actuatable bidirectional clutch mechanisms Ci may prevent rotation of a respective sun gear 129a in the second rotational direction, whereas if the switching mechanism is in its second state, a selective one of the actuatable bidirectional clutch mechanisms Ci may prevent rotation of a respective sun gear 129a in the first rotational direction.

When the planetary gear system input Ip is driven in the first rotational direction R1 about the stationary lay shaft A3, while the switching mechanism is in the first state, the ring gear 128 is also driven in the first rotational direction, and via the stepped planet gear 127, a rotational force is induced on the sun gears 129i in the second, reverse, rotational direction. By braking a selective one of the sun gears 129i in the second rotational direction with a corresponding one of the clutch mechanisms Ci, torque can be transmitted from the ring gear 128 to the planet carrier 126, according to an underdrive transmission ratio. When the planetary gear system input Ip is driven in the first rotational direction about the stationary lay shaft A3, while the switching mechanism is in the second state however, the planet carrier 126 is also driven in the first rotational direction, and via the stepped planet gear 127, a rotational force is induced on the sun gears 129i in the first rotational direction. By braking a selective one of the sun gears 129i in the first rotational direction with a corresponding one of the clutch mechanisms Ci, torque can be transmitted from the planet carrier 126 to the ring gear 128 according to an overdrive transmission ratio.

In each of the first and second dispositions, the actuatable bidirectional clutch mechanisms Ci may be arranged to prevent rotation of the sun gear 129 in one direction, while allowing rotation of the sun gear in the opposite rotation direction, e.g. by freewheeling. Hence, in the first disposition, the actuatable bidirectional clutch mechanism Ci may be configured for allowing freewheeling of the sun gear 129i in the second rotational direction while preventing rotation of that sun gear 129i in the first rotational direction. Also, in the second disposition, the actuatable bidirectional clutch mechanism Ci may be configured for allowing freewheeling of the sun gear 129i in the first rotational direction while preventing rotation of that sun gear 129i in the second rotational direction.

One or more of the actuatable bidirectional clutch mechanisms Ci may also selectively be adjusted to a third disposition. In the third disposition, the actuatable bidirectional clutch mechanism Ci may allow free rotation of the respective sun gear 129i in both rotational directions about the stationary lay shaft A3. For instance, while one of the actuatable bidirectional clutch mechanisms Ci is in the first disposition or the second disposition, other ones of the actuatable bidirectional clutch mechanisms can be in the third disposition. Also, when all bidirectional clutch mechanisms are in the third disposition while the switching mechanism is in its first or second state, no torque will be transferred from the input Ip to the output op of the planetary gear system 100P. Hence, the planetary gear system 100P will be idling. Then toque can be transferred from the input I to the output O of the transmission system 100o via the one way bearing FW, according to a unity transmission ratio.

One or more, e.g. all, of the actuatable bidirectional clutch mechanisms Ci may be configured to be adjustable to be in the third disposition, if the switching mechanism is in its third state, for allowing the ring gear 128 and the planet carrier 126 to corotate about the stationary lay shaft A3. This way, the planetary gear system 100P may provide a unitary transmission ratio between the input Ip and output Op. If the switching mechanism is in its third state, one or more of the actuatable bidirectional clutch mechanisms Ci may also be adjusted to be in the second disposition, for allowing the ring gear 128 and the planet carrier 126 to corotate about the stationary axle 30 in the first rotational direction.

It is possible that one (or more) of the actuatable bidirectional clutch mechanisms Ci is a biased actuatable bidirectional clutch mechanism configured to be in the second disposition by default and configured to be actively actuated to the first disposition. The biased actuatable bidirectional clutch mechanism may be configured not to have a third disposition. Also, the biased actuatable bidirectional clutch mechanism Ci may be configured for allowing freewheeling of the sun gear 129i in the first rotational direction while preventing rotation of that sun gear 129i in the second rotational direction. It is also possible that one (or more) of the actuatable bidirectional clutch mechanisms Ci is a biased actuatable bidirectional clutch mechanism configured to be in the first disposition by default and configured to be actively actuated to the second disposition.

In FIG. 1 the planetary gear system 100P comprises four sun gears 129a, 129b, 129c, 129d meshing with four respective planet radii 127a, 127b, 127c, 127d of the stepped planet gear 127. Also, the plurality of clutch mechanisms Ci comprises four actuatable bidirectional clutch mechanisms C1, C2, C3, C4, arranged for selectively clutching the respective sun gears 129a, 129b, 129c, 129d to the stationary axle 30. A ten-speed transmission system 100o can be hence be obtained. Exemplary clutch states of the switching mechanism (first actuatable clutch mechanism S1 and a second actuatable clutch mechanism S2) and clutch mechanism (actuatable bidirectional clutch mechanisms C1, C2, C3, C4) for the ten-speed transmission system 100o are summarized in table 1. In this example, the transmission ratio of the input transmission stage 100i is 1.6, the transmission ratio of the output transmission stage 100o is 1.56 and a step size between selectable transmission ratios of the planetary gear system is 1.19 (i.e., the planetary gear system has transmission ratios 0.50; 059; 0.71; 0.84; 1.00; 1.19; 1.42; 1.69; 2.01).

TABLE 1

| | | | C1 | C2 | C3 | C4 |
|---|---|---|---|---|---|---|
| | | | (dispo- | (dispo- | (dispo- | (dispo- |
| Gear | S1 | S2 | sition) | sition) | sition) | sition) |
| 1 (1.00) | un- | un- | 3^{rd} | 3^{rd} | 3^{rd} | 3^{rd} |
| | clutched | clutched | | | | |
| 2 (1.24) | un- | un- | 2^{nd} | 3^{rd} | 3^{rd} | 3^{rd} |
| | clutched | clutched | | | | |
| 3 (1.48) | un- | un- | 3^{rd} | 2^{nd} | 3^{rd} | 3^{rd} |
| | clutched | clutched | | | | |
| 4 (1.76) | un- | un- | 3^{rd} | 3^{rd} | 2^{nd} | 3^{rd} |
| | clutched | clutched | | | | |
| 5 (2.10) | un- | un- | 3^{rd} | 3^{rd} | 3^{rd} | 2^{nd} |
| | clutched | clutched | | | | |
| 6 (2.50) | un- | clutched | 3^{rd} | 3^{rd} | 3^{rd} | 3^{rd} |
| | clutched | or | | | | |
| | or | un- | | | | |
| | clutched | clutched | | | | |
| 7 (2.97) | clutched | clutched | 3^{rd} | 3^{rd} | 3^{rd} | 1^{st} |
| 8 (3.53) | clutched | clutched | 3^{rd} | 3^{rd} | 1^{st} | 3^{rd} |
| 9 (4.21) | clutched | clutched | 3^{rd} | 1^{st} | 3^{rd} | 3^{rd} |
| 10 (5.01) | clutched | clutched | 1^{st} | 3^{rd} | 3^{rd} | 3^{rd} |

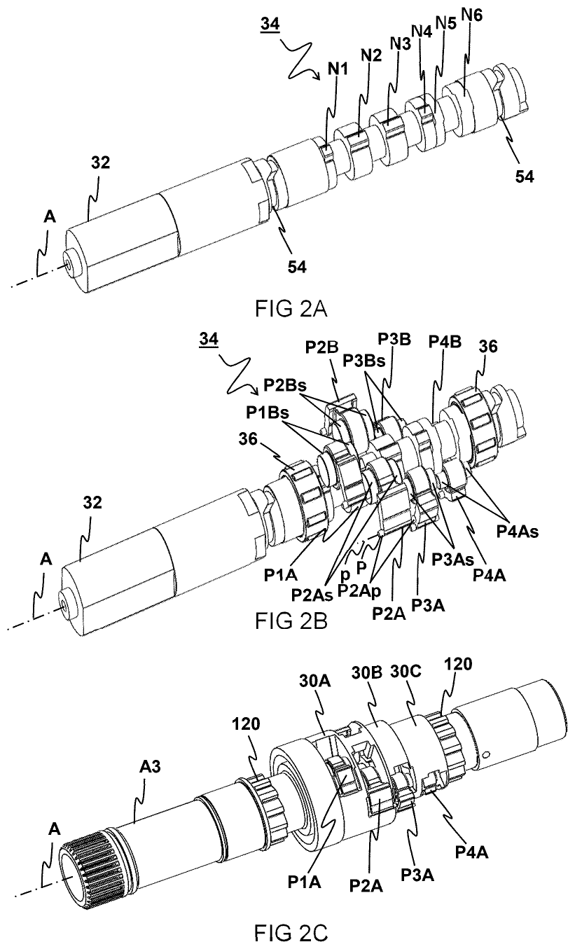

In this example, an actuator 32 for actuating the clutch mechanisms C1, C2, C3, C4 is mounted inside the lay shaft A3. In this example, the actuator 32 is an electromechanical actuator. The electromechanical actuator comprises an electric motor 32 in this example. The actuator in this example comprises a camshaft 34 mounted inside the lay shaft for actuating the clutch mechanisms C1, C2, C3, C4. In the example of FIG. 2A, the motor is positioned coaxially with the camshaft 34. The electromechanical actuator 32 is configured for rotating the camshaft 34 inside the lay shaft 3A. In the example of FIG. 1, the actuator 32 is positioned outside the lay shaft A3.

FIG. 2A shows an example of the actuator. In FIG. 2A the electromechanical actuator 32 and the camshaft 34 are visible. Here, the camshaft comprises a plurality of cams Ni, in particular, six cams N1, N2, N3, N4, N5, N6. Here, the camshaft 34 comprises a single notch profile for actuating the plurality of clutch mechanisms. The singe notch profile is formed by the plurality of cams Ni, extending along an axial direction of the camshaft 34. In this example, the singe notch profile, e.g. the plurality of cams Ni, extends along a line parallel to a central axial axis A of the camshaft 34.

FIG. 2B shows the actuator of FIG. 2A with pawls Pi, in particular pawls P1A, P1B, P2A, P2B, P3A, P3B, P4A, P4B, shown. Each clutch mechanism C1, C2, C3, C4 comprises one or more pawls Pi configured to be actuated by the camshaft 34. In this example, the second C2, third C3 and fourth C4 clutch mechanisms each comprise a first pawl PiA and a second pawl PiB configured to be actuated by the camshaft 34, such that the first pawl PiA is selectively in engagement with the respective sun gear 129i in the first mode, and the second pawl PiB is selectively in engagement with the respective sun gear 129i in the second mode.

Each pawl Pi in this example comprises two support surfaces Pis that are supported on the camshaft 34 and can be lifted by the cams Ni. Here, the support surfaces Pis are formed as bearings, such as roller bearings or plain bearings. In this example, the first pawls P1A, PIB of the first clutch mechanism C1 comprises two support surfaces, here two roller bearings, P1As. P1Bs. The support surfaces Pls are supported on the camshaft 34 and lifted by the cams N1 and N2. A circumferential groove is here provided in the camshaft 34 between the cams N1 and N2 as clearance for the first pawls P1A, P1B. In this example, the first and second pawls P2A, P2B of the second clutch mechanism C2 each comprise two support surfaces, here two roller bearings, P2As, P2Bs. The support surfaces P2As, P2Bs are supported on the camshaft 34 and lifted by the cams N2 and N3. A circumferential groove is here provided in the camshaft 34 between the cams N2 and N3 as clearance for the first and second pawls P2A, P2B. In this example, the first and second pawls P3A, P3B of the third clutch mechanism C3 each comprise two support surfaces, here two roller bearings, P3As, P3Bs. The support surfaces P3As, P3Bs are supported on the camshaft 34 and lifted by the cams N3 and N4. A circumferential groove is here provided in the camshaft 34 between the cams N3 and N4 as clearance for the first and second pawls P3A, P3B. In this example, the first and second pawls P4A, P4B of the fourth clutch mechanism C4 each comprise two support surfaces, here two roller bearings, P4As, P4Bs. The support surfaces P4As, P4Bs are supported on the camshaft 34 and lifted by the cams N5 and N6. A circumferential groove is here provided in the camshaft 34 between the cams N5 and N6 as clearance for the first and second pawls P4A, P4B.

It will be appreciated that it is also possible that the cams of the camshaft 34 are provided with bearings, such as roller bearings or plain bearings for contacting the pawls. In an example, the actuator comprises a rotation sensor and/or a position sensor. Thus, a gear in which the actuator is positioned can be monitored. It is for instance possible to monitor a rotational position of the electromechanical actuator 32 and/or the camshaft 34.

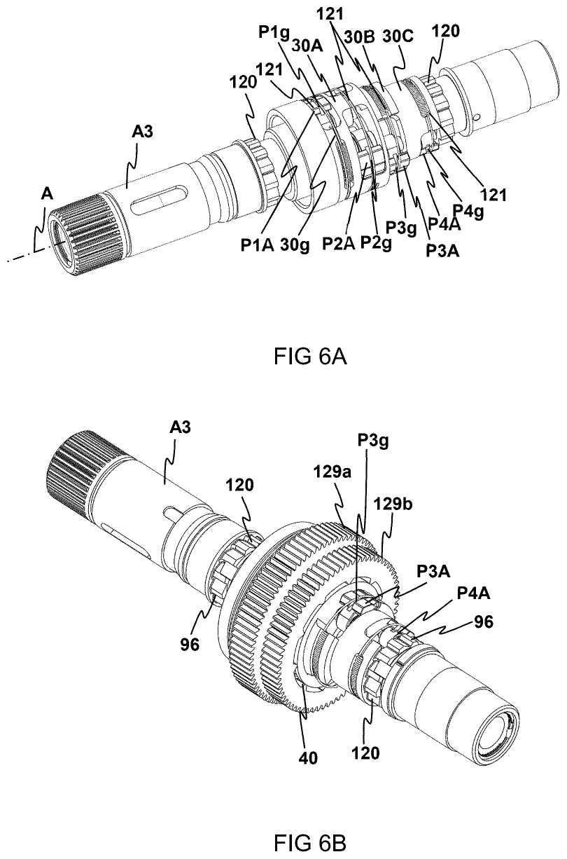

FIG. 6B show an example in which two sun gears 129a, 129b are shown mounted on the lay shaft 3A over the respective pawls P1A, P1B, P2A, P2B. For clarity, the sun gears 129c, 129d are not shown in FIG. 6B.

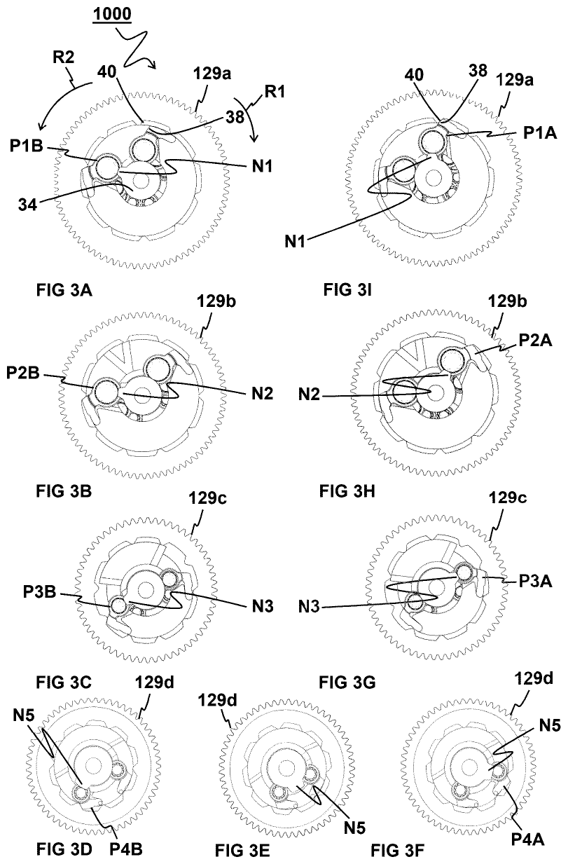

As can be seen in more detail in FIGS. 3A-3I, the pawls associated with larger sun gears in this example also have larger roller bearings for support surfaces, than pawls associated with smaller sun gears.

In this example, in each clutch mechanism C1, C2, C3, C4, the first P1A, P2A, P3A, P4A and second P1B, P2B, P3B, P4B pawls are configured for each pivoting about a respective pivot axis. In this example, each pawl comprises two protrusions Pip forming end of a pivot axle P of the respective pawl. The protrusions P2Bp of the second pawl P2B of the second clutch mechanism C2 are indicated in FIG. 2B. It will be appreciated that the other pawls have similar protrusions in this example.

As can be seen in FIG. 2B, the pawls of the clutch mechanisms C1, C2, C3, C4 are positioned rotated about the central axis A. That is, the pawls P1A, PIB of the first clutch mechanism C1 are positioned rotated about the central axis A relative to the pawls of the second, third and fourth clutch mechanisms C2, C3, C4. The first and second pawls P2A, P2B of the second clutch mechanism C2 are positioned rotated about the central axis A relative to the pawls of the first, third and fourth clutch mechanisms C1, C3, C4. The first and second pawls P3A, P3B of the third clutch mechanism C3 are positioned rotated about the central axis A relative to the pawls of the first, second and fourth clutch mechanisms C1, C2, C4. The first and second pawls P4A, P4B of the fourth clutch mechanism C4 are positioned rotated about the central axis A relative to the pawls of the first, second and third clutch mechanisms C1, C2, C3. Thus, a first position of at least one pawl of at least one of the clutch mechanisms is rotated about the central axis relative to a second position of at least one pawl of at least another one of the clutch mechanisms. Here, a first position of the first and second pawls of at least one of the clutch mechanisms is rotated about the central axis relative to a second position of the first and second pawls of at least another one of the clutch mechanisms. As will be discussed in view of FIGS. 3A-3I, in an example the pawls are positioned such that a rotation of the cam shaft in a single direction successively actuates the respective pawls such that the transmission ratios of the transmission are sequentially selected in an ascending or descending order. In this example, the positions of the pawls are spaced 40 degrees apart. Hence, the camshaft can be rotated over eight times 40 degrees to access nine different transmission ratios.

FIG. 2B further shows two bearings 36, here roller bearings (but plains bearings are also possible) around the camshaft 34, for supporting the camshaft 34 inside the lay shaft A3.

FIG. 2C shows the actuator of FIGS. 2A and 2B inside the axle 30. As shown in FIG. 2C, in this example the lay shaft A3 has a plurality of shaft sections of different outer diameter. In this example a first shaft section 30A has a first outer diameter. The first 129a and second 129b sun gears can be mounted on the first shaft section 30A in this example. A second shaft section 30B has a smaller outer diameter than the first shaft section 30A. The third sun gear 129c can be mounted on the second shaft section 30B in this example. A third shaft section 30C has a smaller outer diameter than the second shaft section 30B. The fourth sun gear 129d can be mounted on the third shaft section 30C in this example. Thus, the lay shaft A3 has a different outer radius at positions of different sun gears 129i of the plurality of sun gears. The different outer diameters of the shaft sections 30A, 30B, 30C can provide ease of assembly of the clutch mechanisms C1, C2, C3, C4. The different outer diameters of the shaft sections 30A, 30B, 30C can provide that a larger diameter shaft section is provided supporting sun gears that transfer higher torque to the lay shaft A3. Preferable, torque is supported from the lay shaft A3 onto the frame of the vehicle, e.g. onto the housing, on the side of the lay shaft A3 having the largest shaft section diameter. In this example, the lay shaft is configured to transfer toque to the crank housing 309 on the side of the output Op of the planetary gear system.

It can also be seen in FIG. 2C that a radial distance between a pivot axis p of the pawls and the central axis A of the shaft A3 is different for different clutch mechanisms C1, C2, C3, C4 of the plurality of clutch mechanisms. For all the pawls Pi, the pivot axis p of the respective pawls Pi is positioned such that the pivot axle P is positioned just below the surface of the respective shaft section. In this example, a first radial distance between the pivot axis p of the first pawls P1A, PIB of the first clutch mechanism C1 and the central axis A of the lay shaft A3 is equal to a second radial distance between the pivot axis p of the first and second pawls P2A, P2B of the second clutch mechanism C2 and the central axis A of the lay shaft A3. In this example, the first radial distance between the pivot axis p of the first and second pawls P2A, P2B of the second clutch mechanism C2 and the central axis A of the lay shaft A3 is larger than a third radial distance between the pivot axis p of the first and second pawls P3A, P3B of the third clutch mechanism C3 and the central axis A of the lay shaft A3. In this example, the third radial distance between the pivot axis p of the first and second pawls P3A, P3B of the third clutch mechanism C3 and the central axis A of the lay shaft A3 is larger than a fourth radial distance between the pivot axis p of the first and second pawls P4A, P4B of the fourth clutch mechanism C4 and the central axis A of the lay shaft A3. It will be appreciated that in this example, a radial distance between the tops of the cams N5, N6 of the fourth clutch mechanism C4 and the central axis A is also smaller than a radial distance between the tops of the cams N1, N2, N3, N4 of the first, second, and third clutch mechanism C1, C2, C3 and the central axis.

The pivot axis p of the pawls is maintained at the radial distance from the central axis A in a pocket fashioned in the lay shaft A3. In particular, the protrusions Pip forming ends of the pivot axle P of the respective pawl are nested in pockets fashioned in the lay shaft A3.

FIGS. 3A-3I show a sequence of gear shifting using the transmission of FIGS. 1-2C. Not shown in FIGS. 3A-3I is the first gear in which the planetary gear system 100P idles as explained above, and the one way bearing FW provides the lowest transmission ratio (first gear), i.e. 1:1 of the transmission system 100o. In this example, When the planetary gear system input Ip is driven in the first rotational direction R1 about the stationary lay shaft A3, while the switching mechanism is in the first state, the ring gear 128 is also driven in the first rotational direction, and via the stepped planet gear 127, a rotational force is induced on the sun gears 129i in the second, reverse, rotational direction. By braking a selective one of the sun gears 129i in the second rotational direction with a corresponding one of the clutch mechanisms Ci, torque can be transmitted from the ring gear 128 to the planet carrier 126, according to an underdrive transmission ratio.

FIG. 3A shows a situation with the planetary system 100P input Ip driven in the first rotational direction R1 about the stationary lay shaft A3, while the switching mechanism is in the first state. The first actuatable bidirectional clutch mechanism C1 is shown in the second disposition in FIG. 3A. The camshaft has been rotated to a first position. The first pawl P1B is actuated by the cam N1, N2 in the first position. An engagement surface of the first pawl PIB engages a corresponding engagement surface associated with the first sun gear 129a, and blocks rotation in the second rotational direction R2. Hence, the first sun gear 129a is braked, and torque is transmitted from the input Ip via the ring gear 128 to the planet gear 127 to the output Op via the planet carrier 126. The transmission ratio is determined by the first sun gear 129a and the first planet gear part 127a, and constitutes a lowest transmission ratio (second gear, underdrive) of the planetary gear system 100P, here the second gear of the transmission system 100o.

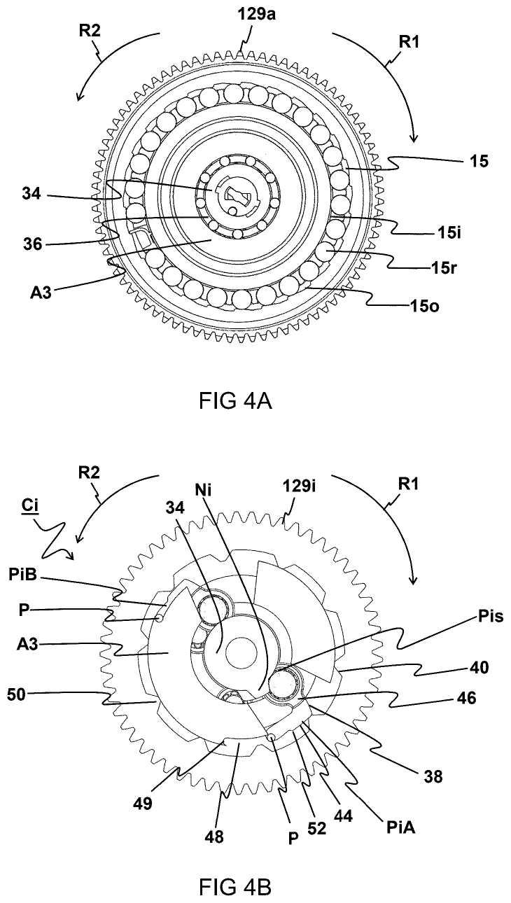

Optionally, e.g. when the one-way bearing FW is not used, the first actuatable bidirectional clutch mechanism C1 can be a biased actuatable bidirectional clutch mechanism having only a single pawl P1. The single pawl P1 is then not actuated by the cam N1, N2 in the first position. The biased actuatable bidirectional clutch mechanism C1 includes a freewheel clutch 15 allowing rotation in the first rotational direction R1, and blocking rotation in the second rotational direction R2. FIG. 4A shows an example of the freewheel clutch 15 of the biased actuatable bidirectional clutch mechanism C1. Here, the freewheel clutch 15 comprises a plurality of rollers 15r, such as balls or cylinders, between an inner race 15i and an outer race 150. In this example, the outer race 150 is provided with a sawtooth profile. Hence, the largest sun gear 129a can be braked, and torque is transmitted from the input Ip via the ring gear 128 to the planet gear 127 to the output Op via the planet carrier 126. The transmission ratio is determined by the first sun gear 129a and the first planet gear part 127a, and constitutes that smallest transmission ratio of the planetary gear system 100P (underdrive).

FIG. 3B shows a situation with the planetary system 100P input Ip driven in the first rotational direction R1 about the stationary lay shaft A3, while the switching mechanism is in the first state. The second actuatable bidirectional clutch mechanism C2 is shown in the second disposition in FIG. 3B. The camshaft has been rotated to a second position. The second pawl P2B is actuated by the cam N2, N3 in the second position. An engagement surface of the second pawl P2B engages a corresponding engagement surface associated with the second sun gear 129b, and blocks rotation in the second rotational direction R2. Hence, the second sun gear 129b is braked, and torque is transmitted from the input Ip via the ring gear 128 to the planet gear 127 to the output Op via the planet carrier 126. The transmission ratio is determined by the second sun gear 129b and the second planet gear part 127b, and constitutes a next higher transmission ratio (third gear) of the transmission system 100o.

FIG. 3C shows a situation with the planetary system 100P input Ip driven in the first rotational direction R1 about the stationary lay shaft A3, while the switching mechanism is in the first state. The third actuatable bidirectional clutch mechanism C3 is shown in the second disposition in FIG. 3C. The camshaft has been rotated to a third position. The second pawl P3B is actuated by the cam N3, N4 in the third position. An engagement surface of the second pawl P2B engages a corresponding engagement surface associated with the third sun gear 129c, and blocks rotation in the second rotational direction R2. Hence, the third sun gear 129c is braked, and torque is transmitted from the input Ip via the ring gear 128 to the planet gear 127 to the output Op via the planet carrier 126. The transmission ratio is determined by the third sun gear 129c and the third planet gear part 127c, and constitutes a next higher transmission ratio (fourth gear) of the transmission system 100o.

FIG. 3D shows a situation with the planetary system 100P input Ip driven in the first rotational direction R1 about the stationary lay shaft A3, while the switching mechanism is in the first state. The fourth actuatable bidirectional clutch mechanism C4 is shown in the second disposition in FIG. 3D. The camshaft has been rotated to a fourth position. The second pawl P4B is actuated by the cam N5, N6 in the fourth position. An engagement surface of the second pawl P4B engages a corresponding engagement surface associated with the fourth sun gear 129d, and blocks rotation in the second rotational direction R2. Hence, the fourth sun gear 129d is braked, and torque is transmitted from the input Ip via the ring gear 128 to the planet gear 127 to the output Op via the planet carrier 126. The transmission ratio is determined by the fourth sun gear 129d and the fourth planet gear part 127d, and constitutes a next higher transmission ratio (fifth gear) of the transmission system 100o.

FIG. 3E shows a situation with the camshaft 34 rotated to a fifth position. In this fifth position, the fourth actuatable bidirectional clutch mechanism C4 is in the third disposition. Thus, neither the first pawl P4A nor the second pawl P4B is lifted by the cams N5, N6. In this situation, the switching mechanism is switched to the third state. This third state can be achieved by bringing the first actuatable clutch S1 in the clutched state and the second actuatable clutch in the un-clutched state. Alternatively, the third state can be achieved by bringing the first actuatable clutch S1 in the un-clutched state and the second actuatable clutch in the clutched state. It will be appreciated that it is also possible to achieve an alternative third state when the first actuatable clutch S1 and the second actuatable clutch are both in the clutched state, and all bidirectional clutch mechanisms C1-C4 are in the third disposition. Thus, the ring gear 128 and the planet carrier 126 are coupled to corotate. Torque is transmitted from the input Ip to the output Op via the ring gear and/or planet carrier 126. It will be appreciated that in this example the cams N5, N6 of the fourth clutch mechanism C4 are wider than the cams N1-N4 of the other clutch mechanisms C1, C2, C3. Hence, a smooth handover from the fourth to the fifth gear (and from the fifth to the sixth gear) can be obtained. This situation constitutes a next higher transmission ratio, which corresponds to a unity transmission ratio of the planetary gear system 100P, corresponding to a sixth gear of the transmission system 100o.

Next, the switching mechanism is switched to the second state. When the planetary system 100P input Ip is driven in the first rotational direction about the stationary axle 30, while the switching mechanism is in the second state, the planet carrier 126 is also driven in the first rotational direction, and via the stepped planet gear 127, a rotational force is induced on the sun gears 129i in the first rotational direction. By braking a selective one of the sun gears 129i in the first rotational direction with a corresponding one of the clutch mechanisms Ci, torque can be transmitted from the planet carrier 126 to the ring gear 128 according to an overdrive transmission ratio.

FIG. 3F shows a situation with the planetary system 100P input Ip driven in the first rotational direction R1 about the stationary lay shaft A3, while the switching mechanism is in the second state. The fourth actuatable bidirectional clutch mechanism C4 is shown in the first disposition in FIG. 3F. The camshaft has been rotated to a sixth position. The first pawl P4A is actuated by the cam N5, N6 in the sixth position. An engagement surface of the first pawl P4A engages a corresponding engagement surface associated with the fourth sun gear 129d, and blocks rotation in the first rotational direction R1. Hence, the fourth sun gear 129d is braked, and torque is transmitted from the input Ip via the planet carrier 126 to the planet gear 127 and to the output Op via the ring gear 128. The transmission ratio is determined by the fourth sun gear 129d and the fourth planet gear part 127d, and constitutes a next higher transmission ratio (seventh gear) of the transmission system 100o. It will be appreciated that shifting from the sixth to the seventh gear can be achieved using various scenarios. In a first scenario, in sixth gear the first actuatable clutch S1 in the clutched state and the second actuatable clutch S2 in the un-clutched state, while all bidirectional clutch mechanisms C1-C4 are in the third disposition. Shifting to the seventh gear can then be achieved by first shifting the second actuatable clutch S2 to the clutched state, and then switching the fourth actuatable bidirectional clutch mechanism C4 to the first disposition. In a second scenario, in sixth gear the first actuatable clutch S1 in the clutched state and the second actuatable clutch S2 in the un-clutched state, while all bidirectional clutch mechanisms C1-C4 are in the third disposition. Shifting to the seventh gear can then be achieved by first switching the fourth actuatable bidirectional clutch mechanism C4 to the first disposition, and then shifting the second actuatable clutch S2 to the clutched state. In a third scenario, in sixth gear the first actuatable clutch S1 in the un-clutched state and the second actuatable clutch S2 in the clutched state, while all bidirectional clutch mechanisms C1-C4 are in the third disposition. Shifting to the seventh gear can then be achieved by first shifting the first actuatable clutch S1 to the clutched state, and then switching the fourth actuatable bidirectional clutch mechanism C4 to the first disposition. In a fourth scenario, in sixth gear the first actuatable clutch S1 in the un-clutched state and the second actuatable clutch S2 in the clutched state, while all bidirectional clutch mechanisms C1-C4 are in the third disposition. Shifting to the seventh gear can then be achieved by first switching the fourth actuatable bidirectional clutch mechanism C4 to the first disposition, and then shifting the first actuatable clutch SI to the clutched state. In a fifth scenario, in sixth gear the first and second actuatable clutches S1, S2 are both in the clutched, while all bidirectional clutch mechanisms C1-C4 are in the third disposition. Shifting to the seventh gear can then be achieved by switching the fourth actuatable bidirectional clutch mechanism C4 to the first disposition.

FIG. 3G shows a situation with the planetary system 100P input Ip driven in the first rotational direction R1 about the stationary lay shaft A3, while the switching mechanism is in the second state. The third actuatable bidirectional clutch mechanism C3 is shown in the first disposition in FIG. 3G. The camshaft has been rotated to a seventh position. The first pawl P3A is actuated by the cam N3, N4 in the seventh position. An engagement surface of the first pawl P3A engages a corresponding engagement surface associated with the third sun gear 129c, and blocks rotation in the first rotational direction R1. Hence, the third sun gear 129c is braked, and torque is transmitted from the input Ip via the planet carrier 126 to the planet gear 127 and to the output Op via the ring gear 128. The transmission ratio is determined by the third sun gear 129c and the third planet gear part 127c, and constitutes a next higher transmission ratio (eighth gear) of the transmission system 100o.

FIG. 3H shows a situation with the planetary system 100P input Ip driven in the first rotational direction R1 about the stationary lay shaft A3, while the switching mechanism is in the second state. The second actuatable bidirectional clutch mechanism C2 is shown in the first disposition in FIG. 3H. The camshaft has been rotated to an eighth position. The first pawl P2A is actuated by the cam N2, N3 in the eighth position. An engagement surface of the first pawl P2A engages a corresponding engagement surface associated with the second sun gear 129b, and blocks rotation in the first rotational direction R1. Hence, the second sun gear 129b is braked, and torque is transmitted from the input Ip via the planet carrier 126 to the planet gear 127 and to the output Op via the ring gear 128. The transmission ratio is determined by the second sun gear 129b and the second planet gear part 127b, and constitutes a next higher transmission ratio (ninth gear) of the transmission system 100o.

FIG. 3I shows a situation with the planetary system 100P input Ip driven in the first rotational direction R1 about the stationary lay shaft A3, while the switching mechanism is in the second state. The first actuatable bidirectional clutch mechanism C1 is shown in the first disposition in FIG. 31. The camshaft has been rotated to a ninth position. The pawl P1A is actuated by the cam N1, N2 in the ninth position. An engagement surface 38 of the pawl P1A engages a corresponding engagement surface 40 associated with the first sun gear 129a, and blocks rotation in the first rotational direction R1. Hence, the first sun gear 129a is braked, and torque is transmitted from the input Ip via the planet carrier 126 to the planet gear 127 and to the output Op via the ring gear 128. The transmission ratio is determined by the first sun gear 129a and the first planet gear part 127a, and constitutes a next higher transmission ratio (tenth gear) of the transmission system 100o.

It will be appreciated that while switching the planetary system 100P through the consecutive gears from the lowest (here second) gear to the highest (here tenth) gear, the sun gears 129i are first used in a sequence from the largest to the smallest sun gear, and subsequently in a sequence from the smallest to the largest sun gear.

FIG. 4B shows an example of a sun gear 129i with an actuatable bidirectional clutch mechanism Ci. The pawls PiA, PiB are in this example generally L-shaped. The pawls PiA, PiB have a first body portion 44 extending from the pivot axle P to the engagement surface 38. The first body portion extends substantially tangentially to the outer surface of the axle 30. The pivot axle P is hingedly supported in a pocket 48 of the lay shaft A3. The pawls PiA, PiB have a second body portion 46 extending substantially radially inwards. The second body portion 46 carries the support surfaces Pis. Here, the second body portion has two axially oriented bosses onto which roller bearings forming the support surfaces Pis are mounted. In this example, the engagement surface 38 of the pawls Pi and the corresponding engagement surface 40 of the sun gear 129i are angled relative to the radial direction. The angle is chosen such that moving the engagement surfaces 38, 40 against and towards each other tends to move the pawl Pi radially inwards. Hence, the pawls Pi are biased to disengage. A spring may be added for spring biased disengagement of the pawls Pi. FIG. 6A shows an example of the pawls Pi biased by a spring 121. Hence, the actuatable bidirectional clutch mechanism Ci is biased to disengage. In the first and second disposition, the presence of the cam Ni underneath the support surfaces Pis prevents the engagement surfaces 38, 40 from disengaging when pressed against each other. In FIG. 4B, the camshaft 34 is positioned such that the clutch mechanism Ci is in the first disposition. In this first disposition, rotating the sun gear 129i in the first rotational direction R1 will force the engagement surfaces against each other, the first pawl PiA is pushed in the pocket 48 against a radial end wall 49 of the pocket 48, and rotation of the sun gear 129i in the first rotational direction is prevented (see corresponding FIG. 3G). FIG. 4B shows the particular situation in which the clutch mechanism Ci is in the first disposition and the sun gear 129i is driven in the second rotational direction R2. The actuatable bidirectional clutch mechanism Ci is configured such that, in the first disposition, the sun gear 129i is prevented from rotating in the first rotational direction R1, but enabled to rotate (freewheel) in the second rotational direction R2. In that case, the protrusions 50 on the inner perimeter of the sun gear 129i will push the first pawl PiA in the first rotational direction, tangentially moving the pawl PiA inside the pocket 48, away from the radial end wall 49 of the pocket, such that the support surfaces Pis drop off the cam Ni. This causes the first pawl PiA to pivot radially inward, such that the engagement surface 38 of the pawl PiA is at a radius that is smaller than the engagement surface 40 of the sun gear 129i. As a result, the sun gear 129i can freewheel in the first rotational direction R1 while the clutch mechanism Ci is in the first disposition. In this example, the first pawl PiA has a protrusion 52, such as a ridge, on a radially outward surface of the pawl PiA. The protrusion 52 can be caught by the protrusion 50 of the sun gear 129i to promote moving the pawl PiA tangentially so as to drop off the cam Ni. In this example, a spring or other resilient element is provided to bias the pawl PiA back into the pocket 48. The spring or other resilient element can pull the pawl, such that the pivot axle P tangentially abuts against the radial end wall of the pocket 48. It will be appreciated that similarly, the actuatable bidirectional clutch mechanism Ci is configured such that, in the second disposition, the sun gear 129i is prevented from rotating in the second rotational direction R2, but enabled to rotate (freewheel) in the first rotational direction R1.

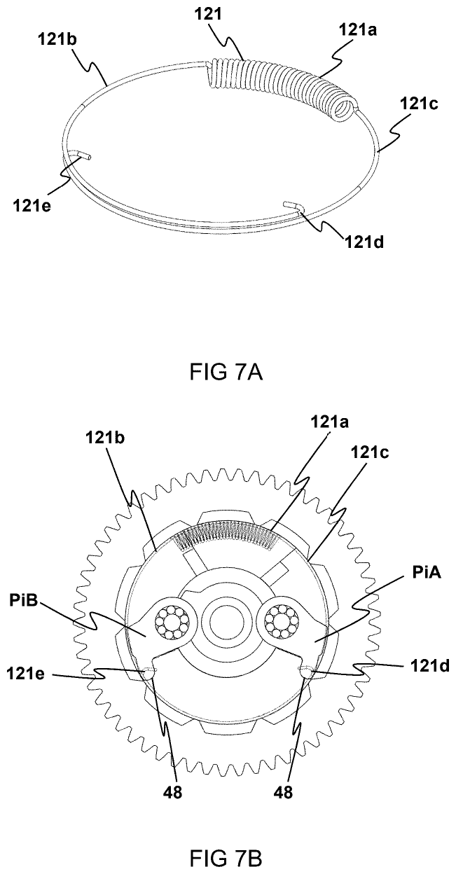

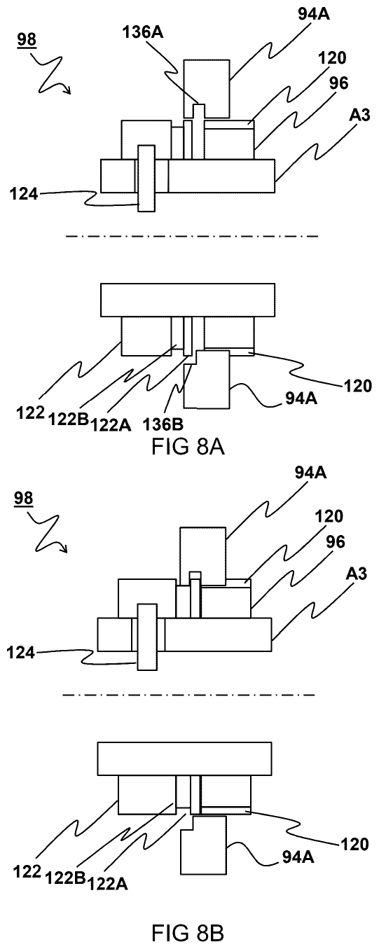

FIG. 7A shows an example in which the spring 121 has the combined function of biasing the pawls PiA, PiB into the pocket 48, and for biasing the pawls PiA, PiB radially inward for biasing disengagement of the engagement surfaces 38, 40. In this example, the spring 121 comprises a helically wound section 121a. Two arms 121b, 121c extend from the ends of the helically wound section. The distal ends of the arms 121b, 121c overlap in this example. Thereby, the spring 121 wraps around the lay shaft A3 over more than 360 degrees. The distal ends of the arms 121b, 121c are each provided with a hook 121d, 121e. In this example, the spring comprises a single helically wound section 121a. It will be appreciated that the spring may also comprise more than one, e.g. two, helically wound sections. As shown in FIG. 8B, the hooks 121d, 121e engage the respective pawls PiA, PiB. Thus, pulling force of the spring 121 biases the pawls PiA, PiB such that the pivot axle P tangentially abuts against a radial end wall of the pocket 48. Also, the arms 121b, 121c of the spring are positioned in circumferential grooves Pig of the pawls PiA, PiB (see e.g. grooves Plg, P2g, P3g, P4g in FIGS. 6A and 6B), such that pulling force of the spring 121 biases the pawls PiA, PiB radially inward. Here, the arms wrap around the pawls PiA, PiB. In this example, the first arm 121b pushes the second pawl PiB radially inwards, and the second arm 121c pushes the first pawl PiA radially inwards. Here, the arms are also positioned in a circumferential groove 30g in the outer surface of the lay shaft A3. In this example, the spring 121 extends between the pawls PiA, PiB, i.e. a first end 121d of the spring is attached to a first pawl PiA, and a second end 121e of the spring is attached to a second pawl PiB. Hence, here the spring 121 pulls the pawls PiA, PiB towards each other. It will be appreciated that it is also possible that each pawl has one or more individual springs associated therewith.

Returning to FIGS. 1 and 2A, the camshaft 34 is in this example further configured for actuating the switching mechanism. In this example, the camshaft comprises one or more grooves 54, here two grooves, for actuating the switching mechanism. The camshaft 34 is configured for axially moving a selector 56 from a first position to a second position or from the second position to the first position. Here, the selector 56 comprises a pen 58 that extends into the groove 54. It will be appreciated that the groove 54 is shaped such that rotation of the camshaft 34 will axially move the pen 58, and thereby the selector 56. The first actuatable clutch S1 and/or the second actuatable clutch S2 is configured to switch from a coupled state to a decoupled state or from a decoupled state to a coupled state upon axial movement of the selector 56. In this example, the groves 54 are shaped such that the first actuatable clutch S1 and the second actuatable clutch S2 from the coupled state to the decoupled state or from the decoupled state to the coupled state substantially simultaneously.

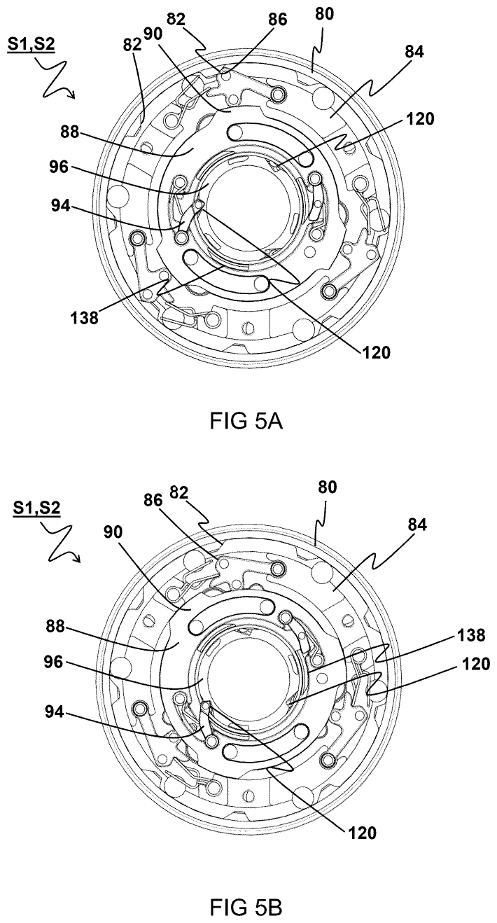

The actuatable clutches S1, S2 of the shifting mechanism can be similar or identical to a clutch as described in WO2018/199757A2, WO2020/085911A2, WO2021/080431A1 or WO2021/249945A1, incorporated herein by reference in their entirety. Referring to FIGS. 5A and 5B, the actuatable clutches S1, S2 can have a first rotatable unit 80 including at least one first abutment surface 82 and a second rotatable unit 84 including at least one second abutment surface 86 arranged for selectively engaging the first abutment surface. The first and second abutment surfaces 82, 86 are adapted to each other so as to allow disengaging under load, preferably in two directions. The actuatable clutches S1, S2 can have a third rotatable unit 88 including at least one retaining member 90. The third rotatable unit 88 is arranged for selectively being in a first mode (FIG. 5A) or a second mode (FIG. 5B) relative to the second rotatable unit 84. In the first mode, the at least one retaining member 90 locks the at least one second abutment surface 86 for rotationally coupling the second rotatable unit 84 to the first rotatable unit 80, e.g. in two rotational directions. In the second mode, the at least one retaining member 90 releases the at least one second abutment surface 86 for decoupling the second rotatable unit 84 from the first rotatable unit 80. The actuatable clutches can include an actuator for moving the third rotatable unit from a first position (FIG. 5A) to a second position (FIG. 5B) or from a second position to a first position relative to the second rotatable unit. Here, the second rotatable unit 84 carries gripping members 92. The gripping members have the second abutment surface 86. The gripping members 92 are pivotally connected to the second rotatable unit 84. In the first position, here, the retaining member 90 is positioned such as to push the second abutment surfaces 86 of the gripping members 92 radially outwards into engagement with the first engagement surfaces 82. In this example, the second engagement surface 86 and the corresponding first engagement surface 82 are angled relative to the radial direction. The angle is chosen such that moving the engagement surfaces 82, 86 against and towards each other tends to move the gripping member 92 radially inwards. Hence, the gripping members 92 are biased to disengage. A spring may be added for spring biased disengagement of the gripping member 92. Hence, the actuatable clutches S1, S2 are biased to disengage. In the first position, the presence of the retaining member underneath the gripping member 92 prevents the engagement surfaces 82, 86 from disengaging when pressed against each other. In the second position, the retaining member 90 is positioned such as to allow the gripping member 92 to pivot radially inwards, to allow disengagement of the second abutment surface 86 from the first engagement surface 82.

The third rotatable unit 88 includes at least one actuation member 94 arranged for moving the third rotatable unit 88 from a first position to a second position or from a second position to a first position relative to the second rotatable unit 84. In this example, the actuatable clutches S1, S2 further includes a fourth unit 96 including a selector 98. The fourth unit 96 can be non-rotatable, e.g. relative to the lay shaft A3. The selector being arranged for selectively being in a gripping or non-gripping mode. The selector 98 in the gripping mode is arranged for gripping the at least one actuation member 94 for rotating the third rotatable unit 88 from the first position to the second position or from the second position to the first position relative to the second rotatable unit 84. The selector 98 in the non-gripping mode is arranged for not engaging the at least one actuation member 94.

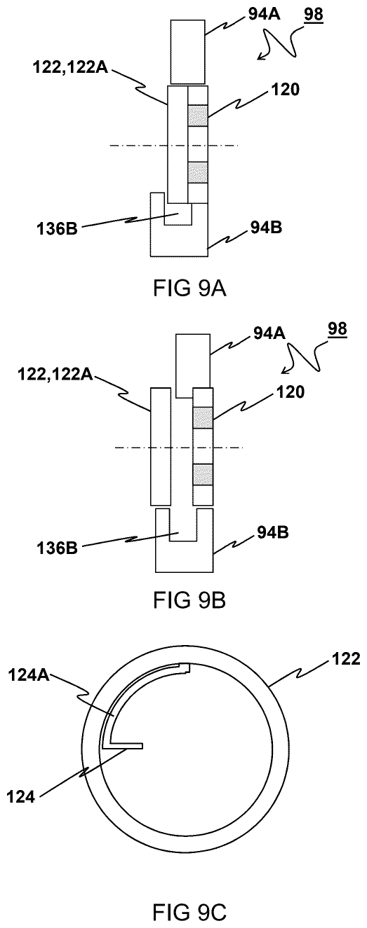

FIGS. 8A and 8B show an example of the selector 98. In this example, the selector includes one or more grooves 120 immobile relative to the lay shaft A3. The selector further includes a selection bush 122 that is axially movable relative to the lay shaft A3. The bush 122 comprises a first section 122A of a first outer diameter, and a second section 122B having a second outer diameter that is smaller than the first outer diameter. In this example, the bush 122 can be axially moved by a pin 124 riding in the groove 54 of the camshaft 34. The bush 122 can be moved into a first position (FIG. 9A) and a second position (FIG. 8B). As can be seen in FIGS. 8A and 8B, in this example the two actuation members 94A and 94B are slightly different. In particular, a cutout 136A, 136B of the respective actuation members 94A, 94B is positioned differently.

With the bush in the first position, as shown in FIG. 8A, the first actuation member 94A rides with its radially inward end on the larger outer diameter first section 122A of the bush. Hence, the first actuation member 94A is prevented from entering the groove 120. With the bush in the first position, as shown in FIG. 8A, the second actuation member 94B has its cutout 136B aligned with the larger outer diameter first section 122A of the bush. Hence, the second actuation member 94A is enabled to enter the groove 120. With the bush in the second position, as shown in FIG. 9B, the second actuation member 94B rides with its radially inward end on the larger outer diameter first section 122A of the bush. Hence, the second actuation member 94B is prevented from entering the groove 120. With the bush in the second position, as shown in FIG. 8B, the first actuation member 94A has its cutout 136A aligned with the larger outer diameter first section 122A of the bush. Hence, the first actuation member 94A is enabled to enter the groove 120. Once the first or second actuation member 94A, 94B enters the groove 120, the third rotatable unit 88 is temporarily halted, causing the third rotatable unit to rotate relative to the second rotatable unit 84. The third rotatable unit 88 will rotate relative to the second rotatable unit 84 from a first position (FIG. 5A) to a second position (FIG. 5B) or from a second position to a first position. Hence, the actuatable clutch S1, S2 will engage or disengage. After the third rotatable unit 88 moving from a first position to a second position or from a second position to a first position, the respective actuation member 94A, 94B is knocked out of the respective groove 120 by a resetting member 138 e.g. corotating with the second rotatable unit 84.

Optionally, a resilient member is placed in the connection between the camshaft 34 and the selection bush 122. The resilient member allows the camshaft 34 to already perform the motion for axially moving the bush 122, while the bush 122 is (temporarily) prevented from actually performing the axial movement, e.g. due to being blocked from performing the axial movement by one or more of the actuation members 94A, 94B. For example, when the first actuation member 94A is in the groove 120, the bush 122 may be prevented from moving from the first position to the second position. If, in this situation, the camshaft is rotated for axially moving the bush 122 from the first position to the second position the resilient member may be deformed. Once the first actuation member 94A is lifted out of the groove, the bush 122 may perform (or finish) the axial movement already imposed by the camshaft 34. For example, when the second actuation member 94B is in the groove 120, the bush 122 may be prevented from moving from the second position to the first position. If, in this situation, the camshaft is rotated for axially moving the bush 122 from the second position to the first position the resilient member may be deformed. Once the second actuation member 94B is lifted out of the groove, the bush 122 may perform (or finish) the axial movement already imposed by the camshaft 34.

The resilient member can be a compliant mechanism. The resilient member can be pre-tensioned, e.g. in two directions, such as two axial directions. The resilient member can e.g. be placed in the bush 122, between the bush 122 and the pin(s) 124, between the pins(s) 124 and the groove 54, and/or between the groove 54 and the camshaft 34.

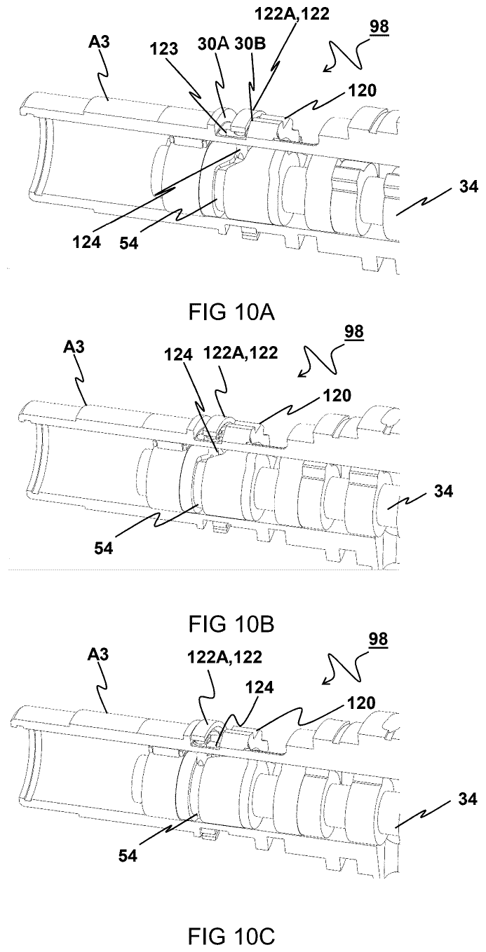

FIGS. 9A-9C show an example of the selector 98. In this example, the selector includes one or more grooves 120 immobile relative to the lay shaft A3. In this example, the selection bush 122 comprises a first section 122A of a first outer diameter. The second section 122B having a second outer diameter that is smaller than the first outer diameter is omitted in this example. Also in this example, the bush 122 can be axially moved by the pin 124 riding in the groove 54 of the camshaft 34. The bush 122 can be moved into a first position (FIG. 9A) and a second position (FIG. 9B). With the bush 122 in the first position, as shown in FIG. 10A, the first actuation member 94A rides with its radially inward end on the outer diameter first section 122A of the bush. Hence, the first actuation member 94A is prevented from entering the groove 120. With the bush in the first position, as shown in FIG. 9A, the second actuation member 94B has its cutout 136B aligned with the outer diameter first section 122A of the bush. Hence, the second actuation member 94A is enabled to enter the groove 120. With the bush in the second position, as shown in FIG. 9B, the second actuation member 94B rides with its radially inward end on the outer diameter first section 122A of the bush. Hence, the second actuation member 94B is prevented from entering the groove 120. With the bush in the second position, as shown in FIG. 9B, the first actuation member 94A is enabled to enter the groove 120. In this example, the first actuation member 94A does not have a cutout 136A. Instead, a width of the first actuation member 94A is chosen such that with the bush in the second position the first actuation member 94A is enabled to enter the groove 120. Once the first or second actuation member 94A, 94B enters the groove 120, the third rotatable unit 88 is temporarily halted, causing the third rotatable unit to rotate relative to the second rotatable unit 84. The third rotatable unit 88 will rotate relative to the second rotatable unit 84 from a first position (FIG. 5A) to a second position (FIG. 5B) or from a second position to a first position. Hence, the actuatable clutch S1, S2 will engage or disengage. After the third rotatable unit 88 moving from a first position to a second position or from a second position to a first position, the respective actuation member 94A, 94B is knocked out of the respective groove 120 by a resetting member 138 e.g. corotating with the second rotatable unit 84.

FIG. 9C shows a side view of an example of the bush 122. In this example, the pin 124 is connected to the bush 122 via a tangential arm 124A. A proximal end of the arm 124A connects to the bush 122, while a distal end of the arm 124A connects to the pin 124. The arm is in this example made of a resilient material, such as a plastics material. The arm 124A can form the resilient member referred to above. The arm allows for the pin already moving in an axial direction of the axle 30, while the bush 122 is still prevented from axially moving by means of the first or second actuation member being positioned in a groove 120.

FIGS. 10A-10C show an example of the selector 98. In this example, the selector includes one or more grooves 120 immobile relative to the lay shaft A3. In this example, the selection bush 122 comprises a first section 122A of a first outer diameter. The second section 122B having a second outer diameter that is smaller than the first outer diameter is omitted in this example. Also in this example, the bush 122 can be axially moved by the pin 124 riding in the groove 54 of the camshaft 34. The pin can e.g. be connected to the bush 122 via an arm 124A as shown in FIG. 9C. The pin extends through a cutout 123 in the lay shaft A3. In an example, the bush 122 has a plurality of pins 124 connected thereto, such as 2 or 3 pins, e.g. evenly distributed about the circumference of the bush 122. The bush 122 can be moved into a first position (FIG. 10A) and a second position (FIG. 10C). As can be seen in FIGS. 10A-10C, the groove 54 has two legs that extend transverse to the longitudinal axis of the camshaft 34. When the pin 124 is in one of the two legs, the bush is in a stable situation in the first or second position, respectively. The arm 124A can be tensioned in the first and/or second position, such that the bush 122 is pressed against an axial face 30A, 30B. Hence, a stable positioning of the bush 122 can be obtained. FIG. 10B shows an intermediate position in which the camshaft 34 is rotated such that the pin 124 is in a slanted portion of the groove 54 that connects the two legs. The two actuation members 94A and 94B can be similar as shown in FIGS. 8A and 8B or 9A and 9B.

The first and second actuation members 94A, 94B, can e.g. be as shown in FIGS. 8A, 8B, 9A or 9B. With the bush 122 in the first position, as shown in FIG. 10A, the first actuation member 94A can ride with its radially inward end on the outer diameter first section 122A of the bush. Hence, the first actuation member 94A is prevented from entering the groove 120. With the bush in the first position, as shown in FIG. 10A, the second actuation member 94B can have its cutout 136B aligned with the larger outer diameter first section 122A of the bush. Hence, the second actuation member 94A is enabled to enter the groove 120. With the bush in the second position, as shown in FIG. 10C, the second actuation member 94B can ride with its radially inward end on the outer diameter first section 122A of the bush. Hence, the second actuation member 94B is prevented from entering the groove 120. With the bush in the second position, as shown in FIG. 8C, the first actuation member 94A can have its cutout 136A aligned with the outer diameter first section 122A of the bush. Alternatively, the first actuation member can have no cutout as described with respect to FIGS. 9A, 9B. Hence, the first actuation member 94A is enabled to enter the groove 120. Once the first or second actuation member 94A, 94B enters the groove 120, the third rotatable unit 88 is temporarily halted, causing the third rotatable unit to rotate relative to the second rotatable unit 84. The third rotatable unit 88 will rotate relative to the second rotatable unit 84 from a first position (FIG. 5A) to a second position (FIG. 5B) or from a second position to a first position. Hence, the actuatable clutch S1, S2 will engage or disengage. After the third rotatable unit 88 moving from a first position to a second position or from a second position to a first position, the respective actuation member 94A, 94B is knocked out of the respective groove 120 by a resetting member 128 e.g. corotating with the second rotatable unit 84.

In an example, the transmission system 100o comprises an electric drive for propelling, or assisting in propelling, the bicycle. The electric drive can be mounted concentrically around the axle 30. Alternatively, the electric drive can be mounted at least partially inside the axle 30. The electric drive can comprise an electric motor. The electric motor can comprise a stator and a rotor. The electric drive can comprise a planetary gear set. The electric drive can comprise a rotation sensor and/or a position sensor.

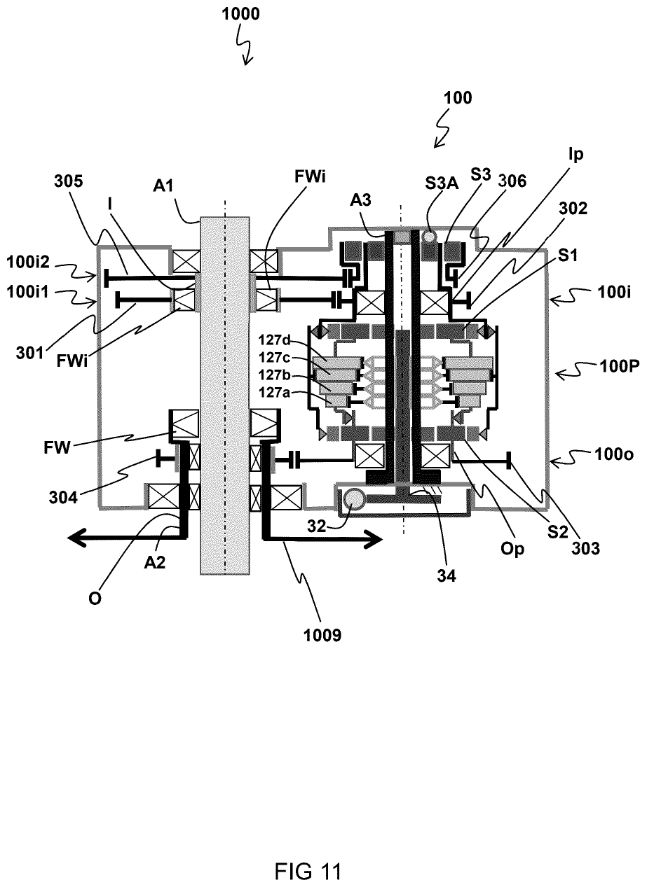

FIG. 11 shows a schematic example of a transmission system 100o for a human powered vehicle or light electric vehicle, such as bicycle. Here, the transmission system 100o is embodied as a crank transmission. The transmission system 100o is similar to the transmission system as described in view of FIGS. 1-10B.

In the example of FIG. 11, the input transmission stage 100i comprises a first torque transfer path 100i1 having a first transmission ratio and a second torque transfer path 10012 having a different second transmission ratio. Here, the second torque transfer path 10012 is more speed increasing than the first torque transfer path 100i1. In an example, the first transmission ration can be about 1.50 and the second transmission ratio can be about 1.64. Hence, a relative difference between the first transmission ratio and the second transmission ratio can be about 9.4%. The input transmission stage 100i is configured for selectively transferring torque to the input Ip of the planetary gear system 100P via the first torque transfer path 100i1 or the second torque transfer path 10012. In this example, the first torque transfer path 100i1 comprises the first gear 301 and the second gear 302. In this example, the second torque transfer path 10012 comprises a fifth gear 305 mounted to the crank axle A1 and a meshing sixth gear 306 mounted to the input Ip of the planetary gear system 100P. It will be appreciated that it is also possible that the first gear 301 drives the second gear 302 via an endless drive member such as a belt or chain. It will be appreciated that it is also possible that the fifth gear 305 drives the sixth gear 306 via an endless drive member such as a belt or chain.

The transmission system 100o of FIG. 11 comprises a third actuatable clutch S3 in the second torque transfer path 10012. The third actuatable clutch S3 is in this example configured to selectively clutch the sixth gear 306 with the input Ip of the planetary gear system 100P. Alternatively, the third actuatable clutch S3 can be configured to selectively clutch the third gear 308 with the crank axle A1 The input transmission stage 100i comprises a freewheel FWi in the first torque transfer path 100i1, here between the crank axle A1 and the first gear 301. The freewheel FWi can also be placed between the second gear 302 and the input Ip of the planetary gear system 100P. The third actuatable clutch S3 can be similar or identical to the first actuatable clutch S1. The third actuatable clutch S3 is configured to be shifted under load. The third actuatable clutch S3 is, in this example, concentric with the lay shaft A3. The third actuatable clutch S3 can have an associated actuator S3A. The actuator S3A can be electronically controlled. It is also conceivable that the third actuatable clutch S3 is actuated via the camshaft 34.

In this example, a step size between two consecutive transmission ratios of the planetary gear system 100P is selected to be about 19.6%. Hence, a relative difference between the first transmission ratio and the second transmission ratio of the input transmission stage 100i is smaller than a step size between two consecutive transmission ratios of the planetary gear system 100P, here about half. Thus, the input transmission stage 100i can provide the transmission system 100o with intermediate transmission ratios between transmission ratios provided by the planetary gear system 100P.

Exemplary clutch states of the switching mechanism (first actuatable clutch mechanism S1 and a second actuatable clutch mechanism S2) and clutch mechanism (actuatable bidirectional clutch mechanisms C1, C2, C3, C4), and the third actuatable clutch S3, for a nineteen-speed transmission system 100o are summarized in table 2. In this example, the transmission ratio of the input transmission stage 100i is selectively 1.50 or 1.64, the transmission ratio of the output transmission stage 100o is 1.5 and a step size between selectable transmission ratios of the planetary gear system is 1.196 (i.e., the planetary gear system has transmission ratios 0.49; 058; 0.70; 0.84; 1.00; 1.20; 1.43; 1.71; 2.05). A step size between consecutive transmission ratios of the transmission system 100o is in this example about 1.093 (9.3%).

TABLE 2

| | | | | C1 | C2 | C3 | C4 |
|---|---|---|---|---|---|---|---|
| | | | | (dis- | (dis- | (dis- | (dis- |
| | | | | po- | po- | po- | po- |
| | | | | si- | si- | si- | si- |
| Gear | S1 | S2 | S3 | tion) | tion) | tion) | tion) |
| 1 (1.00) | un- | un- | un- | 3^{rd} | 3^{rd} | 3^{rd} | 3^{rd} |
| | clutched | clutched | clutched | | | | |
| 2 (1.10) | un- | un- | un- | 2^{nd} | 3^{rd} | 3^{rd} | 3^{rd} |
| | clutched | clutched | clutched | | | | |
| 3 (1.20) | un- | un- | clutched | 2^{nd} | 3^{rd} | 3^{rd} | 3^{rd} |
| | clutched | clutched | | | | | |
| 4 (1.32) | un- | un- | un- | 3^{rd} | 2^{nd} | 3^{rd} | 3^{rd} |
| | clutched | clutched | clutched | | | | |
| 5 (1.44) | un- | un- | clutched | 3^{rd} | 2^{nd} | 3^{rd} | 3^{rd} |
| | clutched | clutched | | | | | |
| 6 (1.57) | un- | un- | un- | 3^{rd} | 3^{rd} | 2^{nd} | 3^{rd} |
| | clutched | clutched | clutched | | | | |
| 7 (1.72) | un- | un- | clutched | 3^{rd} | 3^{rd} | 2^{nd} | 3^{rd} |
| | clutched | clutched | | | | | |
| 8 (1.88) | un- | un- | un- | 3^{rd} | 3^{rd} | 3^{rd} | 2^{nd} |
| | clutched | clutched | clutched | | | | |
| 9 (2.06) | un- | un- | clutched | 3^{rd} | 3^{rd} | 3^{rd} | 2^{nd} |
| | clutched | clutched | | | | | |
| 10 (2.25) | un- | clutched | un- | 3^{rd} | 3^{rd} | 3^{rd} | 3^{rd} |
| | clutched | or un- | clutched | | | | |
| | or | clutched | | | | | |
| | clutched | | | | | | |
| 11 (2.46) | un- | Clutched | clutched | 3^{rd} | 3^{rd} | 3^{rd} | 3^{rd} |
| | clutched | or un- | | | | | |
| | or | clutched | | | | | |
| | clutched | | | | | | |
| 12 (2.69) | clutched | clutched | un- | 3^{rd} | 3^{rd} | 3^{rd} | 1^{st} |
| | | | clutched | | | | |
| 13 (2.94) | clutched | clutched | clutched | 3^{rd} | 3^{rd} | 3^{rd} | 1^{st} |
| 14 (3.22) | clutched | clutched | un- | 3^{rd} | 3^{rd} | 1^{st} | 3^{rd} |
| | | | clutched | | | | |
| 15 (3.52) | clutched | clutched | clutched | 3^{rd} | 3^{rd} | 1^{st} | 3^{rd} |
| 16 (3.85) | clutched | clutched | un- | 3^{rd} | 1^{st} | 3^{rd} | 3^{rd} |
| | | | clutched | | | | |
| 17 (4.21) | clutched | clutched | clutched | 3^{rd} | 1^{st} | 3^{rd} | 3^{rd} |
| 18 (4.60) | clutched | clutched | un- | 1^{st} | 3^{rd} | 3^{rd} | 3^{rd} |
| | | | clutched | | | | |
| 19 (5.03) | clutched | clutched | clutched | 1^{st} | 3^{rd} | 3^{rd} | 3^{rd} |

Thus, a nineteen-speed transmission system 100o can be provided. It will be appreciated that it is also possible to omit the one-way bearing FW to provide an eighteen-speed transmission system 100o. If the one-way bearing FW is omitted, it is not necessary that all selectable transmission ratios are speed-increasing. Hence, it is also possible to select the transmission ratios of the input transmission stage 100i and/or the output transmission stage 100o such that at least one or more of the resulting transmission ratios of the transmission system 100o are speed decreasing (underdrive).

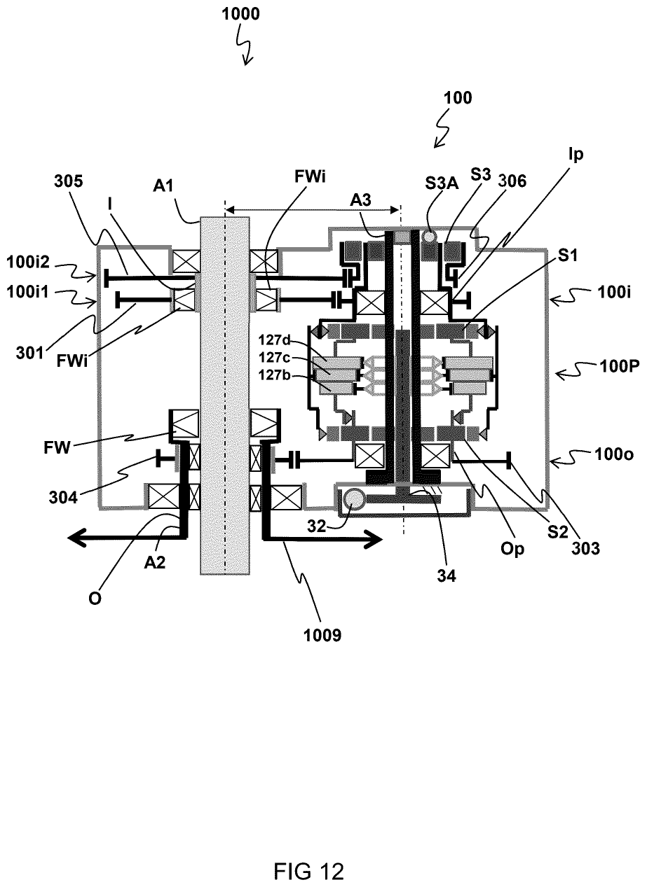

FIG. 12 shows a schematic example of a transmission system 100o for a human powered vehicle or light electric vehicle, such as bicycle. Here, the transmission system 100o is embodied as a crank transmission. The transmission system 100o is similar to the transmission system as described in view of FIG. 11.

In the example of FIG. 12, The planetary gear system 100P comprises three sun gears 127b, 127c, 127d, instead of four sun gears. Hence, the planetary gear system 100P can provide seven different transmission ratios. In combination with the input transmission stage 100i having the first torque transfer path 10011, with the first transmission ratio, and the second torque transfer path 10012, with the different second transmission ratio, a fourteen-speed or fifteen-speed transmission system 100o can be provided. It will be appreciated that the planetary gear system 100P can comprise two, three, four, five, or more sun gears if desired.

Table 3 shows exemplary clutch states of the switching mechanism (first actuatable clutch mechanism S1 and a second actuatable clutch mechanism S2) and clutch mechanism (actuatable bidirectional clutch mechanisms C1, C2, C3, C4), and the third actuatable clutch S3, for a fourteen-speed transmission system 100o. In this example, the transmission ratio of the input transmission stage 100i is selectively 1.50 or 1.70 the transmission ratio of the output transmission stage 100o is 1.00 and a step size between selectable transmission ratios of the planetary gear system is 1.282 (i.e., the planetary gear system has transmission ratios 0.47; 061; 0.78; 1.00; 1.28; 1.64; 2.11). A step size between consecutive transmission ratios of the transmission system 100o is in this example about 1.132 (13.2%).

TABLE 3

| | | | | C1 | C2 | C3 |
|---|---|---|---|---|---|---|
| | | | | (dis- | (dis- | (dis- |
| | | | | po- | po- | po- |
| | | | | si- | si- | si- |
| Gear | S1 | S2 | S3 | tion) | tion) | tion) |
| 1 (0.71) | un-clutched | un-clutched | un- | 2^{nd} or | 3^{rd} | 3^{rd} |
| | | | clutched | freeweel | | |
| 2 (0.81) | un-clutched | un-clutched | clutched | 2^{nd} or | 3^{rd} | 3^{rd} |
| | | | | freeweel | | |
| 3 (0.91) | un-clutched | un-clutched | un- | 3^{rd} | 2^{nd} | 3^{rd} |
| | | | clutched | | | |
| 4 (1.03) | un-clutched | un-clutched | clutched | 3^{rd} | 2^{nd} | 3^{rd} |
| 5 (1.17) | un-clutched | un-clutched | un- | 3^{rd} | 3^{rd} | 2^{nd} |
| | | | clutched | | | |
| 6 (1.32) | un-clutched | un-clutched | clutched | 3^{rd} | 3^{rd} | 2^{nd} |
| 7 (1.50) | un-clutched | Clutched or | un- | 3^{rd} | 3^{rd} | 3^{rd} |
| | or clutched | unclutched | clutched | | | |
| 8 (1.70) | un-clutched | Clutched or | clutched | 3^{rd} | 3^{rd} | 3^{rd} |
| | or clutched | unclutched | | | | |
| 9 (1.92) | clutched | clutched | un- | 3^{rd} | 3^{rd} | 1^{st} |
| | | | clutched | | | |
| 10 (2.18) | clutched | clutched | clutched | 3^{rd} | 3^{rd} | 1^{st} |
| 11 (2.47) | clutched | clutched | un- | 3^{rd} | 1^{st} | 3^{rd} |
| | | | clutched | | | |
| 12 (2.79) | clutched | clutched | clutched | 3^{rd} | 1^{st} | 3^{rd} |
| 13 (3.16) | clutched | clutched | un- | 1^{st} | 3^{rd} | 3^{rd} |
| | | | clutched | | | |
| 14 (3.58) | clutched | clutched | clutched | 1^{st} | 3^{rd} | 3^{rd} |

Thus, a fourteen-speed transmission system 100o can be provided. It will be appreciated that the one-way bearing FW is not used in thes fourteen-speed transmission system 100o.

Table 4 shows exemplary clutch states of the switching mechanism (first actuatable clutch mechanism S1 and a second actuatable clutch mechanism S2) and clutch mechanism (actuatable bidirectional clutch mechanisms C1, C2, C3, C4), and the third actuatable clutch S3, for a fifteen-speed transmission system 100o. It will be appreciated that the one-way bearing FW is used in this fifteen-speed transmission system 100o. In this example, the transmission ratio of the input transmission stage 100i is selectively 1.50 or 1.66 the transmission ratio of the output transmission stage 100o is 1.55 and a step size between selectable transmission ratios of the planetary gear system is 1.224 (i.e., the planetary gear system has transmission ratios 0.55; 067; 0.82; 1.00; 1.22; 1.50; 1.83). A step size between consecutive transmission ratios of the transmission system 100o is in this example about 1.106 (10.6%).

TABLE 4

| | | | | C1 | C2 | C3 |
|---|---|---|---|---|---|---|
| | | | | (dis- | (dis- | (dis- |
| | | | | po- | po- | po- |
| | | | | si- | si- | si- |
| Gear | S1 | S2 | S3 | tion) | tion) | tion) |
| 1 (1.00) | un-clutched | un-clutched | un-clutched | 3^{rd} | 3^{rd} | 3^{rd} |
| 2 (1.27) | un-clutched | un-clutched | un-clutched | 2^{nd} | 3^{rd} | 3^{rd} |
| 3 (1.40) | un-clutched | un-clutched | clutched | 2^{nd} | 3^{rd} | 3^{rd} |
| 4 (1.55) | un-clutched | un-clutched | un-clutched | 3^{rd} | 2^{nd} | 3^{rd} |
| 5 (1.72) | un-clutched | un-clutched | clutched | 3^{rd} | 2^{nd} | 3^{rd} |
| 6 (1.90) | un-clutched | un-clutched | un-clutched | 3^{rd} | 3^{rd} | 2^{nd} |
| 7 (2.10) | un-clutched | un-clutched | clutched | 3^{rd} | 3^{rd} | 2^{nd} |
| 8 (2.33) | un-clutched | clutched or | un-clutched | 3^{rd} | 3^{rd} | 3^{rd} |
| | or clutched | unclutched | | | | |
| 9 (2.57) | un-clutched | clutched or | clutched | 3^{rd} | 3^{rd} | 3^{rd} |
| | or clutched | un-clutched | | | | |
| 10 (2.85) | clutched | clutched | un-clutched | 3^{rd} | 3^{rd} | 1^{st} |
| 11 (3.15) | clutched | clutched | clutched | 3^{rd} | 3^{rd} | 1^{st} |
| 12 (3.48) | clutched | clutched | un-clutched | 3^{rd} | 1^{st} | 3^{rd} |
| 13 (3.85) | clutched | clutched | clutched | 3^{rd} | 1^{st} | 3^{rd} |
| 14 (4.26) | clutched | clutched | un-clutched | 1^{st} | 3^{rd} | 3^{rd} |
| 15 (4.72) | clutched | clutched | clutched | 1^{st} | 3^{rd} | 3^{rd} |

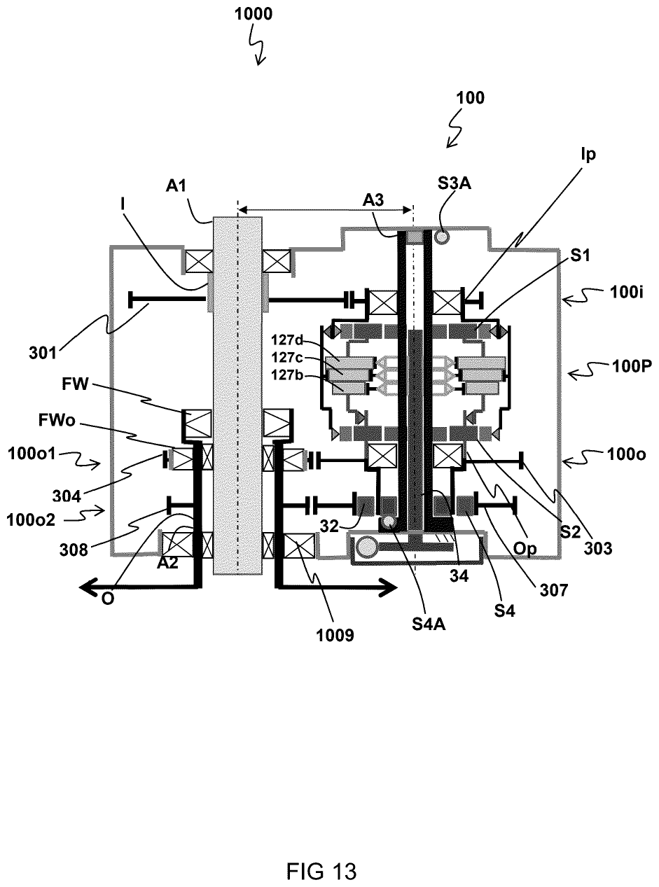

FIG. 13 shows a schematic example of a transmission system 100o for a human powered vehicle or light electric vehicle, such as bicycle. Here, the transmission system 100o is embodied as a crank transmission. The transmission system 100o is similar to the transmission system as described in view of FIG. 12.

In the example of FIG. 13, the output transmission stage 100o comprises a third torque transfer path 100o1 having a third transmission ratio and a fourth torque transfer path 100o2 having a different fourth transmission ratio. Here, the fourth torque transfer path 100o2 is more speed increasing than the third torque transfer path 100o1. In an example, the third transmission ratio can be about 1.50 and the fourth transmission ratio can be about 1.64. Hence, a relative difference between the third transmission ratio and the fourth transmission ratio can be about 9.4%. The output transmission stage 100o is configured for selectively transferring torque from the output Op of the planetary gear system 100P via the third torque transfer path 100o1 or the fourth torque transfer path 100o2. In this example, the third torque transfer path 100o1 comprises the third gear 303 and the fourth gear 304. In this example, the fourth torque transfer path 100o2 comprises a seventh gear 307 mounted to the output Op of the planetary gear system 100P and a meshing eighth gear 308 mounted to the output shaft A2. It will be appreciated that it is also possible that the third gear 303 drives the fourth gear 304 via an endless drive member such as a belt or chain. It will be appreciated that it is also possible that the seventh gear 307 drives the eighth gear 308 via an endless drive member such as a belt or chain.

The transmission system 100o of FIG. 13 comprises a fourth actuatable clutch S4 in the fourth torque transfer path 100o2. The fourth actuatable clutch S4 is in this example configured to selectively clutch the seventh gear 307 with the output Op of the planetary gear system 100P. Alternatively, the fourth actuatable clutch S4 can be configured to selectively clutch the eighth gear 308 with the output shaft A2. The output transmission stage 100o comprises a freewheel FWo in the third torque transfer path 100o1, here between the fourth gear 304 and the output shaft A2. The freewheel FWo can also be placed between the third gear 303 and the output Op of the planetary gear system 100P. The fourth actuatable clutch S4 can be similar or identical to the first actuatable clutch S1. The fourth actuatable clutch S4 is configured to be shifted under load. The fourth actuatable clutch S4 is, in this example, concentric with the lay shaft A3. The fourth actuatable clutch S4 can have an associated actuator S4A. The actuator S4A can be electronically controlled. It is also conceivable that the fourth actuatable clutch S4 is actuated via the camshaft 34.

For instance a fourteen-speed or fifteen-speed transmission system 100o can be provided within the example of FIG. 13. Such a fourteen-speed or fifteen-speed transmission system 100o can e.g. be as explained with respect to tables 3 and 4, wherein the third actuatable clutch S3 is replaced by the fourth actuatable clutch S4.

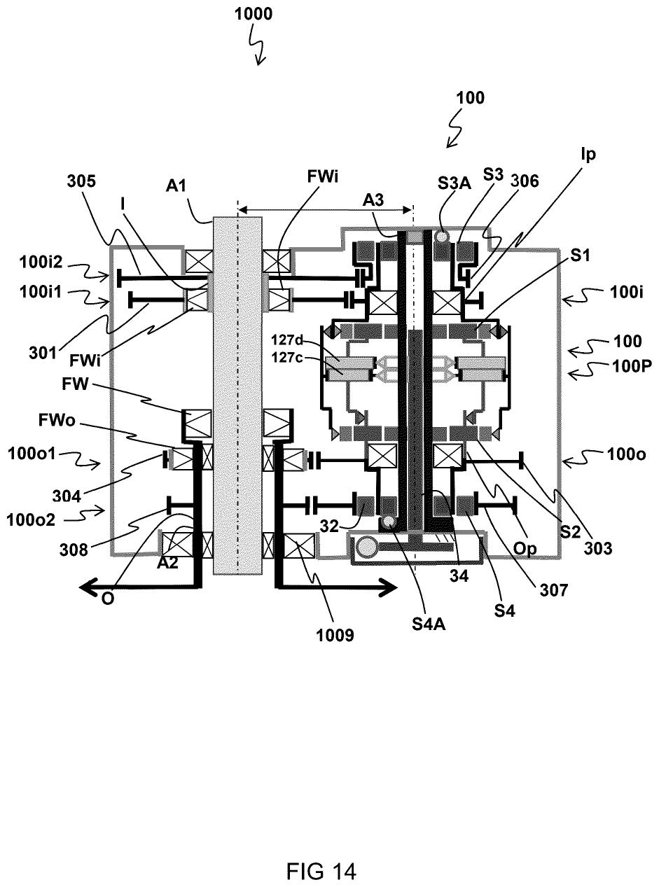

FIG. 14 shows a schematic example of a transmission system 100o for a human powered vehicle or light electric vehicle, such as bicycle. Here, the transmission system 100o is embodied as a crank transmission. The transmission system 100o is similar to the transmission system as described in view of FIGS. 12 and 13.

In this example, the input transmission stage 100i comprises the first torque transfer path 100i1 and the second torque transfer path 10012, and the output transmission stage 100o comprises the third torque transfer path 100o1 and the fourth torque transfer path 100o2.

In the example of FIG. 14, The planetary gear system 100P comprises two sun gears 127c, 127d, instead of three sun gears. Hence, the planetary gear system 100P can provide five different transmission ratios. In combination with the input transmission stage 100i having the first torque transfer path 100i1, with the first transmission ratio, and the second torque transfer path 10012, with the different second transmission ratio, and the output transmission stage 100o having the third torque transfer path 100o1, with the third transmission ratio, and the fourth torque transfer path 100o2, with the different fourth transmission ratio, a twenty-speed or twentyone-speed transmission system 1000 can be provided. It will be appreciated that the planetary gear system 100P can comprise two, three, four, five, or more sun gears if desired.

In this example, a step size between two consecutive transmission ratios of the planetary gear system 100P is selected to be about 19.6%. Hence, a relative difference between the first transmission ratio and the second transmission ratio of the input transmission stage 100i is smaller than a step size between two consecutive transmission ratios of the planetary gear system 100P, here about half. Thus, the input transmission stage 100i can provide the transmission system 1000 with intermediate transmission ratios between transmission ratios provided by the planetary gear system 100P.

Exemplary clutch states of the switching mechanism (first actuatable clutch mechanism S1 and a second actuatable clutch mechanism S2) and clutch mechanism (actuatable bidirectional clutch mechanisms C1, C2, C3, C4), and the third actuatable clutch S3, for a nineteen-speed transmission system 100o are summarized in table 5. In this example, the transmission ratio of the input transmission stage 100i is selectively 1.50 or 1.62, the transmission ratio of the output transmission stage 100o is selectively 1.375 or 1.62 and a step size between selectable transmission ratios of the planetary gear system is 1.38 (i.e., the planetary gear system has transmission ratios 0.53; 0.72; 1.00; 1.38; 1.90). A step size between consecutive transmission ratios of the transmission system 1000 is in this example about 1.083 (8.3%).

TABLE 5

| | | | | | C1 | C2 |
|---|---|---|---|---|---|---|
| | | | | | (dis- | (dis- |
| | | | | | po- | po- |
| | | | | | si- | si- |
| Gear | S1 | S2 | S3 | S4 | tion) | tion) |
| 1 (1.00) | un-clutched | un-clutched | un- | un- | 3^{rd} | 3^{rd} |
| | | | clutched | clutched | | |
| 2 (1.08) | un-clutched | un-clutched | un- | un- | 2^{nd} | 3^{rd} |
| | | | clutched | clutched | | |
| 3 (1.17) | un-clutched | un-clutched | clutched | un- | 2^{nd} | 3^{rd} |
| | | | | clutched | | |
| 4 (1.28) | un-clutched | un-clutched | un- | clutched | 2^{nd} | 3^{rd} |
| | | | clutched | | | |
| 5 (1.38) | un-clutched | un-clutched | clutched | clutched | 2^{nd} | 3^{rd} |
| 6 (1.49) | un-clutched | un-clutched | un- | un- | 3^{rd} | 2^{nd} |
| | | | clutched | clutched | | |
| 7 (1.61) | un-clutched | un-clutched | clutched | un- | 3^{rd} | 2^{nd} |
| | | | | clutched | | |
| 8 (1.76) | un-clutched | un-clutched | un- | clutched | 3^{rd} | 2^{nd} |
| | | | clutched | | | |
| 9 (1.90) | un-clutched | un-clutched | clutched | clutched | 3^{rd} | 2^{nd} |
| 10 (2.06) | un-clutched | clutched or | un- | un- | 3^{rd} | 3^{rd} |
| | or clutched | unclutched | clutched | clutched | | |
| 11 (2.23) | un-clutched | clutched or | clutched | un- | 3^{rd} | 3^{rd} |
| | or clutched | unclutched | | clutched | | |
| 12 (2.43) | un-clutched | clutched or | un- | clutched | 3^{rd} | 3^{rd} |
| | or clutched | unclutched | clutched | | | |
| 13 (2.62) | un-clutched | clutched or | clutched | clutched | 3^{rd} | 3^{rd} |
| | or clutched | unclutched | | | | |
| 14 (2.85) | clutched | clutched | un- | un- | 3^{rd} | 1^{st} |
| | | | clutched | clutched | | |
| 15 (3.07) | clutched | clutched | clutched | un- | 3^{rd} | 1^{st} |
| | | | | clutched | | |
| 15 (3.35) | clutched | clutched | un- | clutched | 3^{rd} | 1^{st} |
| | | | clutched | | | |
| 17 (3.62) | clutched | clutched | clutched | clutched | 3^{rd} | 1^{st} |
| 18 (3.93) | clutched | clutched | un- | un- | 1^{st} | 3^{rd} |
| | | | clutched | clutched | | |
| 19 (4.24) | clutched | clutched | clutched | un- | 1^{st} | 3^{rd} |
| | | | | clutched | | |
| 20 (4.63) | clutched | clutched | un- | clutched | 1^{st} | 3^{rd} |
| | | | clutched | | | |
| 21 (5.00) | clutched | clutched | clutched | clutched | 1^{st} | 3^{rd} |

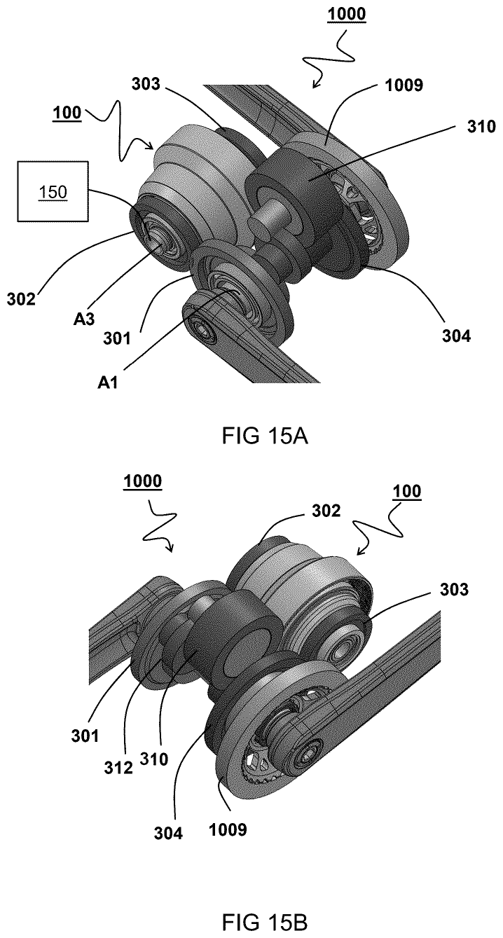

FIGS. 15A and 15B show an example of a transmission system 1000 for a human powered vehicle or light electric vehicle, such as a bicycle, similar to the example of FIGS. 1-14. In the example of FIGS. 15A and 15B, an electric propulsion motor 310 is offset and parallel to the crank axle A1. Here, the motor 310 drives the transmission input I. The motor 310 can e.g. drive the crank axle 1004 or the first gear 301, e.g. via a freewheel. Here, the motor 310 drives the first gear 301 via a speed reduction 311, e.g. comprising an intervening gear 312. It will be appreciated that it is also possible that the propulsion motor 310 is arranged concentric with the crank axle A1.

In an alternative example, the electric propulsion motor 310 drives the input Ip of the planetary gear system 100P. The electric motor 310 can drive the input of the planetary gear system 100P downstream of the input transmission stage 100i. The electric motor 310 can e.g. drive an output of the input transmission stage 100i. The electric propulsion motor 310 can e.g. drive the second gear 302. Hence, there can be a gear train from the electric motor 310 to the second gear 302. This gear train can exclude the first gear 301 (and the fifth gear 305).

It is also possible that a further gear is mounted to the input Ip of the planetary gear system 100P, such as concentric with the lay shaft A3. The electric propulsion motor can e.g. drive this further gear. Hence, there can be a gear train from the electric motor 310 to the further gear. This gear train can exclude the first gear 301 and second gear 302 (and the fifth gear 305 and sixth gear 306).

The bicycle transmission 1000 further comprises control electronics 150 for controlling the actuator(s), e.g. the electromechanical actuator 32 and/or S3A and/or S4A. The control electronics can comprise at least one of a controller, generator, battery, PCB, wireless receiver/transmitter, antenna, LED, charge plug, connector, or micro-chip. In an example, the control electronics are mounted in the housing 308.

A receiver of the control electronics 150 can be configured for receiving a shift control signal, such as from a shifter 1024. The shift control signal can be representative of a desired transmission gear (e.g. first gear, second gear, third gear, etc.). The shift control signal can be representative of upshift or downshift. The controller can be configured for, on the basis of the shift control signal controlling the actuator, such as the electromechanical actuator. Alternatively, or additionally, the controller can be configured for autonomously changing a transmission gear, e.g. on the basis of a current transmission gear, a wheel speed, a cadence, a torque, and/or a heart rate. Particularly when the transmission system comprises the generator and is configured for autonomously changing the transmission ratio, a self-contained autonomous transmission can be provided. Optionally, characteristics of the transmission system, such as parameters on when to shift gears can be adjusted by a user, e.g. using an interface, such as on a mobile communications device, such as a smartphone, in (wireless) communication with the control electronics.

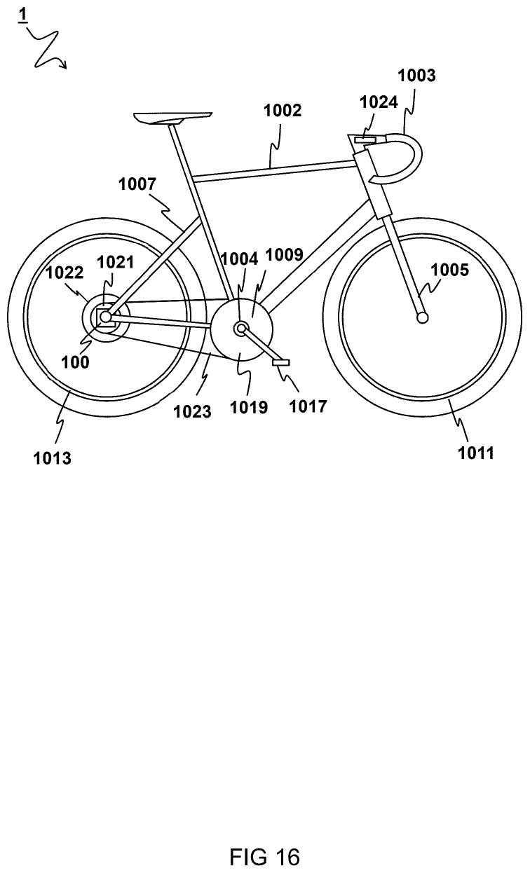

FIG. 16 shows an example of a bicycle 1. The bicycle includes a frame 1002 and a front fork 1005. The bicycle includes a handlebar 1003. A front wheel 1011 is mounted to the front form 1005. The frame 1002 includes a rear fork 1007 having a rear wheel 1013 mounted thereto. A crank axle 1004 is mounted to the frame 1002. The crank axle 1004 can be connected to the housing 308, the housing 308 being connected to the frame. Pedals 1017 are connected to the crank axle 1004. A front sprocket 1009 is also connected to the crank axle 1004. The rear wheel is provided with a hub 1022. A rear sprocket 1021 is connected to the hub. In this example, the rear sprocket 1021 is connected to the hub 1022. The crank axle 1004 is connected to the front sprocket 1009 via a transmission system 1000, e.g. as described above. The front sprocket 1009 drives the rear sprocket 1021 via an endless member, such as a chain or belt. The bicycle 1 in this example includes a shifter 1024 configured for transmitting a shift control signal to a receiver of the control electronics 150 of the transmission system 1000.

Herein, the invention is described with reference to specific examples of embodiments of the invention. It will, however, be evident that various modifications and changes may be made therein, without departing from the essence of the invention. For the purpose of clarity and a concise description features are described herein as part of the same or separate embodiments, however, alternative embodiments having combinations of all or some of the features described in these separate embodiments are also envisaged.

In the examples, a planetary gear system is provided using two, three or four different sun gears. It will be appreciated that it is also possible to provide the transmission system 1000 with a planetary gear system with more sun gears. The number of planet gear parts of different radii of the stepped planet gears can correspond to the number of different sun gears.

In the example, each sun gear is associated with an actuatable bidirectional clutch mechanism configured for in a first mode selectively preventing rotation of the at least one sun gear in a first rotational direction about the axle (and optionally allowing rotation of the at least one sun gear in an opposite second rotational direction about the axle), and in a second mode selectively preventing rotation of the at least one sun gear in the opposite second rotational direction about the axle (and optionally allowing rotation of the at least one sun gear in the first rotational direction about the axle), for providing two different transmission ratios with one sun gear. It will be appreciated that it is possible that the transmission system further includes one or more sun gears having an associated unidirectional clutch mechanism configured for in a first mode selectively preventing rotation of the at least one sun gear in a first rotational direction about the axle (and optionally allowing rotation of the at least one sun gear in the opposite second rotational direction about the axle), and in a second mode allowing rotation of the at least one sun gear in the first rotational direction (and optionally allowing rotation of the at least one sun gear in the opposite second rotational direction about the axle).

However, other modifications, variations, and alternatives are also possible. The specifications, drawings and examples are, accordingly, to be regarded in an illustrative sense rather than in a restrictive sense.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A transmission system for a human powered vehicle, or light electric vehicle, such as a bicycle, comprising:
a crank housing;
a crank axle;
a front sprocket mounted to an output shaft concentric with the crank axle;
a transmission having an input connected to the crank axle and an output connected to the output shaft, wherein the transmission comprises
a planetary gear system, configured to be operated according one of a plurality of different selectable transmission ratios, mounted on a lay shaft which is offset and parallel to the crank axle,
an input transmission stage for transmitting torque from the crank axle to an input of the planetary gear system, and
an output transmission stage for transmitting torque from an output of the planetary gear system to the output shaft.

2. The transmission system of claim 1, wherein the input transmission stage has a speed increasing transmission ratio.

3. The transmission system of claim 1, wherein the input transmission stage comprises a first gear mounted to the crank axle and a meshing second gear mounted to the input of the planetary gear system.

4. The transmission system of claim 1, wherein the output transmission stage has a speed increasing transmission ratio.

5. The transmission system of claim 1, wherein the output transmission stage comprises a third gear mounted to the output of the planetary gear system and a meshing fourth gear mounted to the output shaft.

6. The transmission system of claim 1, wherein the planetary gear system has speed increasing and/or speed decreasing transmission ratios.

7. The transmission system of claim 1, wherein the planetary gear system comprises at least three sun gears rotatably mounted around the lay shaft, configured for in a first mode selectively being prevented to rotate in a first rotational direction about the lay shaft, and optionally in a second mode selectively being prevented to rotate in an opposite second rotational direction about the lay shaft.

8. The transmission system of claim 7, wherein the at least three sun gears have different diameters and are connected by at least one stepped planet gear rotatably mounted inside a carrier.

9. The transmission system of claim 8, wherein a largest planet part of the at least one stepped planet gear is positioned towards the input of the planetary gear system.

10. The transmission system of claim 1, wherein the planetary gear system is configured to selectively transfer torque from the input of the planetary gear system to the ring gear or to the carrier of the planetary gear set.

11. The transmission system of claim 1, wherein the input transmission stage comprises a first torque transfer path having a first transmission ratio and a second torque transfer path having a different second transmission ratio, wherein the input transmission stage is configured for selectively transferring torque to the input of the planetary gear system via the first torque transfer path or the second torque transfer path, wherein the first torque transfer path optionally comprises the first gear and the second gear, and the second torque transfer path comprises a fifth gear mounted to the crank axle and a meshing sixth gear mounted to the input of the planetary gear system, optionally wherein the second torque transfer path is more speed increasing than the first torque transfer path.

12. (canceled)

13. The transmission system of claim 1, wherein the output transmission stage comprises a third torque transfer path having a third transmission ratio and a fourth torque transfer path having a different fourth transmission ratio, wherein the output transmission stage is configured for selectively transferring torque to the output shaft via the third torque transfer path or the fourth torque transfer path, wherein optionally the third torque transfer path comprises the third gear and the fourth gear, and the fourth torque transfer path comprises a seventh gear mounted to the output of the planetary gear system and a meshing eighth gear mounted to the output shaft, optionally wherein the third torque transfer path is more speed increasing than the fourth torque transfer path.

14. (canceled)

15. The transmission system of claim 1, wherein:
the planetary gear system is configured to be operated according to at least five different selectable transmission ratios, and the input and output transmission stages are configured to, together, be operated according to at least three different selectable transmission ratios; or
the planetary gear system is configured to be operated according to at least seven different selectable transmission ratios, and the input and output transmission stages are configured to, together, be operated according to at least two different selectable transmission ratios.

16. The transmission system of claim 11, wherein a transmission ratio difference between the first torque transfer path and the second torque transfer path, and/or between the third torque transfer path and the fourth torque transfer path, is smaller than a transmission ratio step size between successive transmission ratios of the planetary gear system.

17. The transmission system of claim 1, comprising a one way bearing coupling the crank axle to the output shaft.

18. The transmission system of claim 1, wherein all transmission ratios of the transmission are speed increasing.

19. The transmission system of claim 1, comprising an electric propulsion motor connected to the input of the transmission system or the input of the planetary gear system.

20. A bicycle transmission having a transmission input and a transmission output, and comprising:
an axle, such as a wheel axle or a layshaft in a crank transmission, having a central axis;
at least three sun gears rotatably mounted around the axle, wherein each of the at least three sun gears meshes with a planet gear part of a stepped planet gear carried by a planet carrier, each planet gear part having a different radius, and wherein at least one planet gear part meshes with a ring gear;
a switching mechanism arranged for being adjustable between a first state for establishing a torque transmission from the transmission input to the ring gear and from the planet carrier to the transmission output, and a second state for establishing a torque transmission from the transmission input to the planet carrier and from the ring gear to the transmission output;
at least three clutch mechanisms, each associated with a respective one of the sun gears, at least two of the clutch mechanisms configured for in a first mode selectively preventing rotation of the associated sun gear in a first rotational direction about the axle, and in a second mode selectively preventing rotation of the associated sun gear in an opposite second rotational direction about the axle;
a camshaft mounted inside the axle for actuating the at least three clutch mechanisms;
wherein the at least two clutch mechanisms each comprise a first pawl and a second pawl configured to be actuated by the camshaft, such that the first pawl is selectively in engagement with the respective sun gear in the first mode, and the second pawl is selectively in engagement with the respective sun gear in the second mode.

21. A human powered vehicle or light electric vehicle, such as a bicycle, comprising the transmission system of claim 1.

22. The vehicle of claim 21, comprising an electric propulsion motor concentrically connected to a rear wheel and/or comprising an electric propulsion motor concentrically connected to a front wheel of the vehicle.
